(19) United States
(12) Patent Application Publication
(10) Pub. No.: US 2003/0112370 A1
(43) Pub. Date: Jun. 19, 2003

(54) Adaptive expanded information capacity for communications systems

(76) Inventors: Chris Long, Maple Valley, WA (US); Thomas J. Endres, Seattle, WA (US); Walt Ciciora, Southport, CT (US); Ted E. Hartson, Scottsdale, AZ (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/246,084

(22) Filed: Sep. 18, 2002

Related U.S. Application Data
(63) Continuation-in-part of application No. 10/319,671, filed on Aug. 9, 2002.
(60) Provisional application No. 60/374,216, filed on Apr. 19, 2002.
(60) Provisional application No. 60/341,931, filed on Dec. 18, 2001.

(51) Int. Cl. H04N 7/084

(52) U.S. Cl. 348/474

(57) ABSTRACT

Methods and systems for effectuating simultaneous transmission of a standard analog television video signal and a data signal. A transmitter system comprises an analog video signal path and a data signal path. The data signal path produces a data signal that is added to, combined with, or otherwise imposed on the video signal, so as to be substantially in quadrature with the video signal as sensed by television receivers in the broadcast region. An abatement signal is generated and applied to the video signal in order to correct for effects of the data on the video signal. The abatement signal is generated based on feedback control metric signals obtained from receiver emulation which uses as input a signal corresponding to the television signal as transmitted. The feedback control metric signals can also used to control the modulation of the data, for example, by adjusting the interpolation of the data based on the amplitude and frequency responses of the data signal. The transmitter system also comprises a subsystem which produces phase and amplitude correction signals for compensating for non-linear distortions in the transmitter system. The metrics can also be used in combination with a reference path to control timing of the data signal as applied to the video signal for output to the transmitter. Receivers according to various embodiments of the present invention separate the data from the video signal, do appropriate processing on the data signal in order to extract and recover the data, and forward the data for output. Such receivers can also include or contain, if desired, output to television receivers for rendering television programming.

### CONTINUATION-IN PART

This is a continuation-in-part of application U.S. Ser. No. ______, filed Aug. 9, 2002 entitled “Expanded Information Capacity for Existing Communication Transmission Systems,” Ciciora, et al inventors, which is a continuation in part of U.S. Pat. No. 6,433,835 titled “Expanded Information Capacity for Existing Communication Transmission Systems,” which is also International Application Number PCT/US99/08513, filed on Apr. 16, 1999 entitled “Expanded Information Capacity for Existing Communication Transmission Systems,” both of which are incorporated herein by this reference. This document also relies on the priority of U.S. Ser. No. 60/374,216 “Spread Subcarrier Modulation As a Method to Increase Rates With Which Digital Data May Be Embedded in NTSC or PAL Television Carrier” which is incorporated herein by this reference, as well as U.S. S No. 60/341,931 “Self Initialized Decision Feedback Equalizer with Automatic Gain Control” which is incorporated herein by this reference.

### TECHNICAL FIELD

This invention relates to systems and methods for simultaneously transmitting television signals and digital signals, and in particular, to systems and methods for providing appropriate compensation and correction when modulating digital signals onto television signals so that the digital signals are substantially orthogonal to the television signals and essentially undetectable and not displayed by consumer grade television receivers.

### BACKGROUND

The digital revolution of the late 20th century engendered a significant demand for what has come to be called “rich media”, including, among other things, video, digital music, animation, and various interactive commercial transactions. While significant advances have been made in distributing digital information city-to-city, considerable delay and inefficiency still exists in the so-called “last mile”; a term used to designate the final link between the terminus of the broadband telecommunications infrastructure (such as a phone switch or fiber hub) and the end consumer of the information in either a residence or business.

Meanwhile, the long-established analog television broadcast infrastructure that has been in use for over half a century to broadcast full motion video information to what are now about 300 million television sets in the United States, has not yet been used successfully to transmit broadband digital information. Despite the advances that have been made in digital television (“DTV”) technology, market acceptance to date has been poor due to issues regarding indoor reception and interference combined with relative consumer satisfaction with the quality of existing analog television performance and lack of interest in investing in new equipment to receive programming which seems only marginally better in visual quality. Further, broadcasters are faced with the economic conundrum of having to make substantial new investments in equipment and facilities for DTV but with no incremental revenues to pay for them. While these issues are expected to be solved in time, the substantial installed base of analog television receivers implies that analog broadcast television will continue to exist as a viable medium for many years more.

At the same time, consumers continue to desire additional speed and richness in the nature and quality of the digital content they receive. With the proliferation of personal computers in the 1990's, easy-to-use graphical interfaces now facilitate users selecting and watching MPEG and other streaming video content, listening to MP3 files of music, conduct telephone conversations over The Internet (sometimes accompanied by video) and process and store digital images JPEG or other formats. The weak link, however, remains the previously-mentioned “last mile” which acts as a bottle neck; decreasing the speed with which large digital files may be moved to the end-user. The current options to cover this “last mile” include telephone plant in the form of twisted pair or DSL, cable television connections to a special modem, satellite links, electrical power lines, and local over-the-air interfaces such as MMDS and LMDS. Each of these options presents its own issues, whether in the form of cost, limited bandwidth, excessive noise, constraints imposed by volume of on-line activity, insufficient switching/routing capacity, and transmission interference.

In addition to the issues presented by these last mile options, an overarching constraint is imposed by the fact that most digital communications to the end-user are currently delivered in the form of point-to-point communications. Whether the transport medium is digital, analog, or a combination, ultimately, packets of content must be addressed and delivered to the user's address via circuit switching, packet switching, or both. Accordingly, considerable switching and routing activity is required to deliver bandwidth-intensive content such as MPEG video on an infrastructure such as The Internet that was originally engineered only for text messaging. Although sufficient fiber has been installed in many areas from city to city and out to neighborhoods, the current bottlenecks are slower development of switching and routing equipment. That constraint may have partially hidden slower development and installation of sufficient network switching and routing capacity to accommodate the demand that will be imposed when users have the “last mile” connectivity and equipment necessary to realize on their desire for video, audio and other rich media content.

Various embodiments of the present invention exploit at least two significant advantages over the conventional infrastructure. First, they present an alternative to the phone, cable, power line, satellite, and local wireless interfaces. (In addition, the bandwidth which may be broadcast according to these embodiments is not power, transponder, or expense—constrained to the extent that satellite communications are.) Second, they provide systems that are eminently suited for high bandwidth content, such as movie and video, distribution, because they use a broadcast architecture. This eliminates the need for the massive processing power and hardware for routing and switching data packets in a point-to-point architecture.

Such embodiments of the present invention exploit the fact that the analog television signal is based on a system designed over a half century ago that does not use the maximum information capacity of the standard 6 MHz that each channel occupies of the television spectrum, and thus that there is an opportunity to add more information to it without degrading its ability to still carry the television programming it was intended to carry.

However, adding information to the analog television spectrum is not a straightforward endeavor. The broadcast analog television spectrum is a delicate envelope, whether NTSC, PAL, or otherwise. These standards were developed in the mid-20^{th} century based on then-existent discrete vacuum tube based technology and to meet certain expense and performance requirements needed to drive the mass market acceptance of this new medium. To accommodate the massive user base of legacy analog television receivers, the transmission standards have remained essentially intact, even with the subsequent introduction of color television and stereo sound with all the additional information they require. Accordingly, subsequent efforts to introduce more information into the analog television channel spectrum can not be permitted to materially interfere with the video or sound quality presented by the existing user base of black and white and color television receivers. A number of efforts have been made over the years to address these issues, as are summarized and discussed in the previously referenced U.S. Ser. No. 09/062,225. The inventors have discovered, however, new and useful techniques and circuits for introducing digital information into an analog television signal channel without materially affecting the video or audio quality of the content as received and displayed by consumer grade television receivers.

### SUMMARY

Various embodiments of the present invention provide apparatus, methods and systems for effectuating a simultaneous transmission of a standard analog television signal and a digital data signal which may carry rich content of the sort discussed above, among other things. Embodiments of the present invention may be installed at a television broadcast facility and connected to a standard television station transmitter to effect the simultaneous propagation of both the existing television programming and a relatively high bandwidth digital data transmission in such a manner that standard television receivers continue to receive and display programming that is not perceptually impaired, yet special data receivers can detect and extract the intact digital signal. A preferred transmitter embodiment comprises a standard television signal path and a data signal path. Ultimately, the data is provided modulated substantially in quadrature to the video carrier thus rendering it theoretically “invisible” to the television receiver.

However, despite the data being modulated essentially in quadrature, due to the complex effects of various filters and other components in commercial television receivers and the variability in design from manufacture to manufacturer, some degradation of the picture quality may occur due to the presence of the data. Conversely, the data encoding process can result in the loss of the integrity of some data. Accordingly, embodiments of the present invention also include other novel circuits and processes for anticipating possible distortions and pre-correcting for them to improve the final picture quality as displayed by the television receiver as well as improving the amount and quality of data that may be successfully transported and then extracted from the signal.

Abatement

A first such technique for improving performance of systems according to various embodiments of the present invention includes “abating” or correcting the transmitted video signal for the effects of the digital data signal. In such embodiments, the television signal as it is to be transmitted is sampled before the power amplifier stage of the television broadcast facility or at another appropriate point for certain “channel metrics”. These channel metrics can include, among other things, the injection phase of the data signal, insertion level, data channel equalization, abatement equalization, abatement optimization and synchronization offset control signals. These metrics are fed to, among other circuits, an abatement signal generator which, in one or more stages generates a correction signal in order to correct for effects of the data on the video signal. In a preferred embodiment, the abatement generator comprises a plurality of abatement stages for iteratively generating the abatement signal.

Transmitter and Other Nonlinear Effects Adjustments

Various embodiments of the present invention also include correction for non-linear distortions in the television signal that are inherent in the process of amplifying it for transmission. Some or all of the channel metrics, in addition to the (abated if desired) video signal if desired, can be applied to a look up table or other circuits which reflect change of transmitter properties over time or other transmitter characteristics. A phase correction signal and an amplitude correction signal can be generated in order to adjust various parameters, including the data signal and, if desired, a reference signal generated by a loop for affecting up-conversion of the data signal to RF in order to harmonize it with the video signal.

Data Up-conversion Adjustment

Various embodiments of the present invention are adapted to provide such a reference signal using, for example a phase locked loop (PLL) that is driven in part by a down-converted signal from the video signal after the exciter stage (or from another appropriate point). The PLL can also use input from the look up table to reflect transmitter nonlinearities, as well as insertion phase adjustment, if desired, in order to control the local oscillator synthesis for the data up-conversion.

Data Filtering Adjustments

Various embodiments of the present invention can also use the channel metrics generated by a monitor receiver to adjust filtering or other treatment of the data signal. For instance, the channel metrics can be provided to either or both Nyquist compensation circuitry, vestigial sideband filtering, in addition to other circuits in order to further improve performance of such embodiments.

Monitor Receivers/Emulators

Television monitor receivers according to various embodiments of the present invention can include, among other things, one or more circuits that emulate or constitute portions of consumer grade television receivers whose geographic locations within the receiving area can also be emulated if desired. Such monitor receivers can also be software modeled entirely and thus in virtual form. They may emulate performance of a variety of television receivers, weight the response, and use the weighted response in order to generate channel metrics that can be used as discussed above.

DSP Implementation

According to other embodiments of the present invention, much of the data and video signal related circuits and processes can be implemented in digital signal processing (DSP) circuits and software using techniques conventional in this field, thus providing additional flexibility and upgradeability.

Receivers

Receivers according to some embodiments of the present invention can receive the combined data/video signal generated and transmitted according to the present invention, including the standard television signal and the data signal, and, among other things, can recover at least data-related signals such as data estimate signals. These signals can be filtered to obtain a predicted data output signal. According to some embodiments of the invention, a video estimate signal is filtered to predict an undesirable component in the predicted data output signal. A combiner can be used to subtract the undesirable component from the predicted data output signal.

Receivers according to some embodiments of the present invention can also include, among other things, a symbol estimator and a symbol combiner. The symbol estimator generates a symbol estimate signal and the symbol combiner subtracts the predicted data output signal from the symbol estimate signal to produce a symbol error signal. The symbol error signal can be fed to adjust at least one adaptive filter used to produce the predicted data output signal and the undesirable component in the predicted data output signal. In some embodiements of the present invention the adaptive filters perform both adaptive equalization and adaptive video (noise) cancellation using known techniques such as the least mean square (LMS) algorithm. Other embodiments may use other known adaptive equalization methods such as Recursive Least-Squares (RLS) algorithms or other known methods for blind deconvolution such as stochastic gradient decent, Polyspectra or Bussgang approaches among others. A preferred embodiment of a receiver device of the present invention also can include a sync recovery processor and a forward gain controller in order to take advantage of strong synchronization and timing properties of NTSC and other standard analog television signals.

### BRIEF DESCRIPTION OF THE DRAWINGS

FIG. 1 is a functional block diagram showing portions of a preferred embodiment of transmitter-side systems according to one aspect of the invention.

FIG. 2 is a data signal frequency plot taken at point 2-2 of the system of FIG. 1.

FIG. 3 is an expanded data signal frequency plot corresponding to the plot shown in FIG. 2.

FIG. 4 is a video signal frequency plot taken at point 4-4 of the system of FIG. 1.

FIG. 5 is a data signal frequency plot taken at point 5-5 of the system of FIG. 1.

FIG. 6A is a functional block diagram of one version of a generator which may generate injection phase channel metrics for use in the system of FIG. 1.

FIG. 6B is a functional block diagram of a reference phase channel metric circuit which may be used with the generator of FIG. 6A in the system of FIG. 1.

FIG. 6C is a functional block diagram of a data phase channel metric circuit which may be used with the generator of FIG. 6A in the system of FIG. 1.

FIG. 7 is a functional block diagram of a monitor receiver which may be used in the system of FIG. 1.

FIG. 8 is a functional block diagram of a data channel equalization metric circuit which may be used in the system of FIG. 1.

FIG. 9 is a functional block diagram of a synchronization offset channel metric circuit which may be used in the system of FIG. 1.

FIG. 10 is a functional block diagram of an abatement equalization channel metric circuit which may be used in the system of FIG. 1.

FIG. 11 is a functional block diagram of an abatement optimization channel metric circuit which may be used in the system of FIG. 1.

FIG. 12 is a functional block diagram showing one form of abatement signal generator which may be used in the system of FIG. 1.

FIG. 13 is a functional block diagram showing one form of cascaded abatement signal generators which may be used in the system of FIG. 1.

FIG. 14 is a functional block diagram showing one form of a video reference generator which may be used with abatement signal generators such as shown in FIGS. 12 and 13.

FIG. 15A is a functional block diagram of portions of a preferred embodiment of a receiver which may be used in accordance with the present invention.

FIG. 15B is a functional block diagram of additional portions of a preferred embodiment of a receiver which may be used in accordance with the present invention.

FIG. 15C is a functional block diagram of an alternative version of the embodiment shown in 15B

FIG. 16 is a plot of a Quadrature Amplitude Modulation Constellation after video cancellation and equalization in the receiver of FIG. 15.

FIG. 17 is a plot of a QAM constellation showing television transmitter amplifier non-linear effects that occur in the receiver of FIG. 15.

FIGS. 18A and B are plots of a QAM constellation illustrating how the Constant Modulus Algorithm may be used for blind equalization.

### DETAILED DESCRIPTION

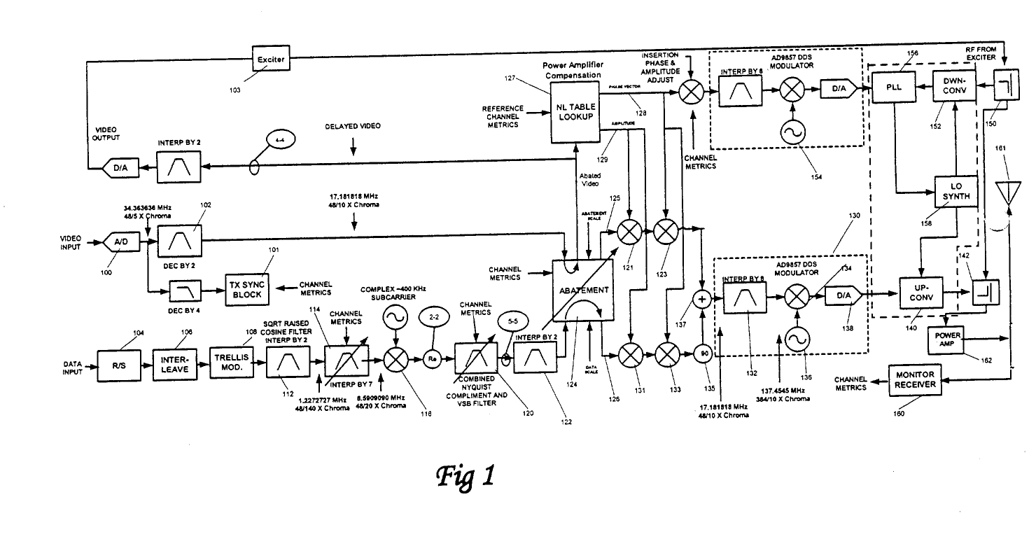

Data transmitter and receiver systems according to preferred embodiments of the present invention are shown in FIGS. 1-17. Briefly stated, the systems transmit and receive data in quadrature to a standard television signal's visual carrier, preferably as received by television receivers. By modeling or emulating a standard TV receiver or receivers for feeding back information to the transmitter encoder apparatus, the transmitter uses adaptive techniques to ensure that the data in the transmitted signal stays locked in perfect or near perfect quadrature with the video carrier as seen at the input to a television receiver's video detector circuit and to present television programming at the receiver without material visual effects from the data.

The data transmission systems of the present invention include a data transmission input chain and a video input chain. The system takes advantage of the strong synchronization and timing properties of the TV video signal in order to simplify recovery of the data imposed by the data transmitter of the invention. An NTSC TV signal will be used as an exemplary TV signal herein. Those skilled in the art will recognize that the present invention is not limited to NTSC signals, but is easily applicable to the PAL television signal used world wide.

Video Signal Path and Use of Video Signal for Synchronization

The discussion that follows in this “Detailed Description” section, as well as the drawings, relates to the embodiment shown in FIG. 1, which is given as an example to show certain (but not all) ways, among others, in which various aspects of embodiments of the present invention can be made and used. These figures and this discussion is intended, therefore, to illustrate some aspects of some embodiments of the present invention, and it should not be construed to limit the invention to various circuits or processes, or to require presence of various circuits or processes, or combinations of them, in order to achieve the present invention, aspects of the present invention or circuits or processes that fall within the scope of the present invention. In the event that any portion of this “Detailed Description” section is quoted, then this paragraph should accompany that quote for proper interpretation of that portion, and is incorporated by reference therein for that purpose.

Accordingly, FIG. 1 shows baseband video, such as from any conventional television programming source, applied to an A-to-D converter (“A/D”) 100. The signal is sampled at about 34 mega-samples per second (“Msps”). It is sampled down (decimated) by a factor of 2 to approximately 17 Msps by a divide-by-2 filter, 102. The data transmitter of the invention intercepts the video signal before exciter 103, which comprises a first stage of a standard TV transmitter.

A delay can be introduced in the video path prior to output to the standard TV transmitter. That delay accounts for all the processing delays through the forward chain of the data encoding system so that at the point of injection of the data onto the video, all of the video-derived components of the composite signal injected by the data encoder are in synchronization with the actual video that is transmitted as the television signal. The delay equals the difference between the processing delay through the data transmitter and the delay through the TV transmitter.

A transmitter synchronization circuit 101 extracts from the video signal timing and synchronization information, such as the time locations of the horizontal and vertical sync intervals, the sync tip levels, and the frequency and phase of the chroma subcarrier. The transmitter synchronization circuit 101 uses the video signal decimated by 4. Conventional methods can be used to extract the timing and synchronization information.

The extracted chroma subcarrier frequency and phase provide a master clock that forms the basis for driving all the data processing in the embodiment shown in FIG. 1, such as, among other things, A/Ds, D/As, and frequency shifting of data signals. When the data carrier signal is added to the visual carrier signal, the video carrier is approximately 20 dB higher than the data signal. In brief, this relatively high power visual carrier signal provides the timing required to align the data with the video at the point of injection.

Data Signal Path and the Front End Data Processing

The data, which can be encapsulated, for example, in MPEG-2 transport packets, is first introduced to a Reed-Solomon forward error correction encoder 104, which expands the data from a 188 byte length to 208 bytes. The data is then subject to an interleave function 106 which scrambles the blocks in time. On the receiver side, if there is a large burst error, that burst is broken up and spread out over a large number of blocks, so as to give the code a much better chance of recovering from the errors. The Reed-Solomon coder along with the interleaver allows detection and correction of up to six bytes of error out of each 200 byte input block. These techniques are known in the art. The data is then subject to a standard trellis code modulation (“TCM”) 108.

The signal is then interpolated by two and filtered by a square root raised cosine (SRRC) filter, collectively designated as 112. The output of the interpolator by two and the SSRC filter 112 is a complex baseband signal with unique upper and lower side bands. That is, the carrier is at DC or 0 Hz.

The data signal is then interpolated by seven (“Interp By 7”) at filter 114 to ensure that the system has enough excess bandwidth to process the signal without producing aliasing components. The interpolator appends six zeros after each data point, as is known in the art. The Inter By 7 circuit also receives channel metric control (“CMC”) signals as discussed below from a monitor receiver for reasons described below. After interpolation by seven, the complex baseband QAM signal is at a rate of approximately 8.6 MHz, which represents 613 K symbols/second, i.e., it is sampled at 14 samples per symbol.

In one embodiment of the present invention, a mixer 116 multiplies the complex baseband QAM signal by a complex 400 KHz subcarrier and shifts the QAM signal by 400 KHz. Other embodiments may involve shifting the QAM signal by as much as 850 KHz to take advantage of an additional reduction in impairment that results from the shift in spectral energy away from the video carrier and away from the main region of sensitivity of the video detectors found in consumer grade television receivers. In addition to this reduced impairment of the video signal, such a shift also mitigates the receiver system phase noise and the attendant corruption of the desired data signal by in-phase elements such as the video and video synch.

Another embodiment of the invention might include a means for dynamically selecting from a number of QAM constellations to optimize data throughput depending on the predicted average receiver's signal-to-noise ratio. This approach enables the operator of the system to take advantage shifts in the quality of RF signal propagation that occur between daytime and night, or which are related to weather or other temporary conditions, or to optimize a particular system for the Rf propagation characteristics of the local terrain or the distance to the intended receiver or other purposes.

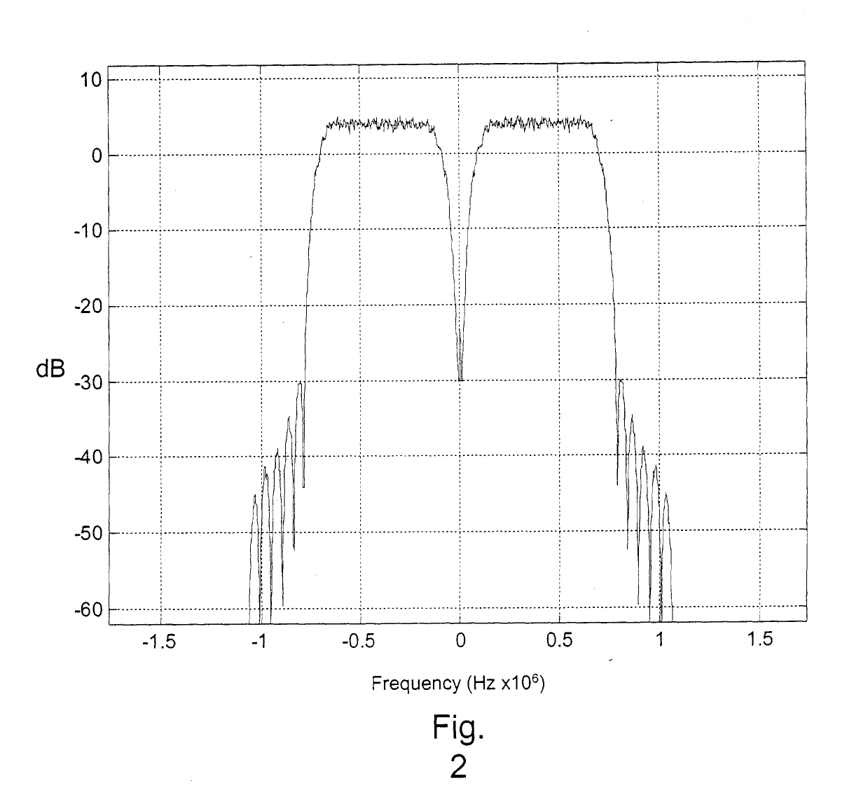

The transmitter system then takes the real part of the result, which creates a real signal having both positive and negative frequency components. This is combined and after other manipulations and adjustments is passed to the TV station's power amplifier 159 and tapped to obtain out going channel metrics 160 as it passes to the TV station's transmission tower 161. FIG. 2 illustrates the real part of the output from the mixer 116.

Referring to FIG. 2, a frequency plot of the data signal at point 2-2 of FIG. 1, the total bandwidth occupied by the real signal fits within the plus or minus 750 KHz double side band (DSB) region of the NTSC signal around the video carrier. Such bandwidth ensures that none of the energy enters the VSB transition region and prevents distortion by the VSB filter. Additionally, this technique results in effectively no data energy at DC, which in this figure will later map to the video carrier. The video carrier has its strongest energy around the DC value hence the separation of the data subcarrier from DC substantially reduces interference.

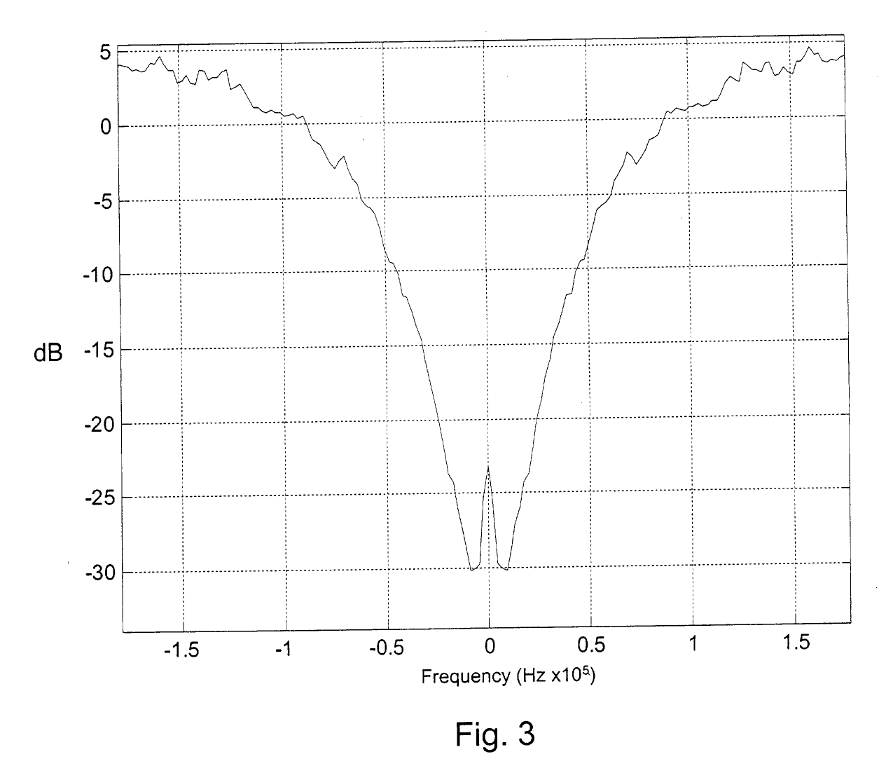

Referring to FIG. 3, which expands the frequency plot of FIG. 2, the data energy is more than 10 dB below peak energy within +/−50-60 KHz of the video carrier. Because it is difficult to maintain quadrature, this “notch” reduces the potential for interference by the video information at the video carrier, which is approximately 20 dB greater than the data energy in one embodiment.

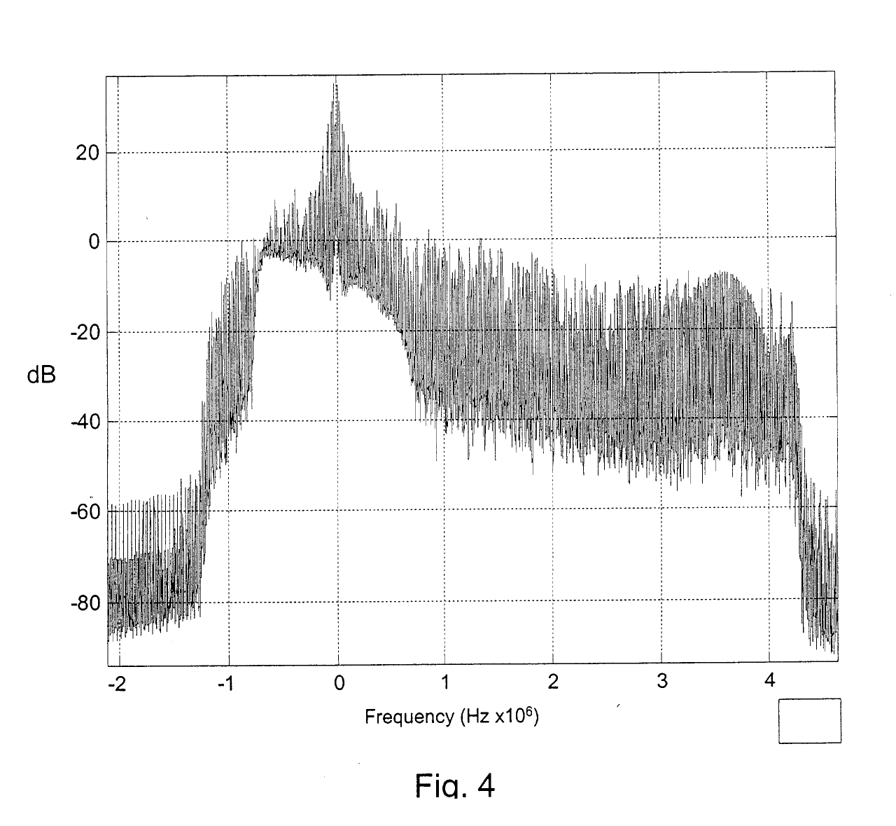

FIG. 4 is an NTSC video carrier frequency plot which illustrates, as one would expect, that most of the video energy is concentrated around the video carrier. The data transmission system achieves this wave shape, that is, a notch around the video carrier, bandwidth within +/−750 KHz, through choice of the symbol rate and the SRRC filtering function. For example a square root raised cosine filter matched to the 613 Kilosymbol rate with an excess bandwidth factor of 0.25 was used in the particular embodiment illustrated in FIGS. 3 and 4. The filter is chosen to keep impulse response short.

Phase noise is also concentrated primarily in a “close-in” region +/−50 to 100 KHz around the visual carrier. Phase noise is caused by fluctuations in the instantaneous phase of the visual carrier resulting from the television transmission and reception processes. By shaping the waveform in the manner described above, and using a subcarrier instead of direct quadrature modulation, the transmitter system essentially achieves a very large amount of cancellation of the phase noise during subsequent detection. This happens because the data subcarrier (“dNTSC”) represents a double sideband signal which is detected and from which a baseband signal is derived by folding the sidebands of the data subcarrier on top of each other. Thus, the instantaneous phase noise components in the lower sideband largely cancel the same but now inverted instantaneous phase noise components in the upper sideband.

In addition to reducing the effect of the video on the data, the embodiment shown in FIG. 1 also reduces the interference effect of the data on the video. Translating the data energy to a higher frequency reduces the perceptibility of the data signal at the TV receiver. TV detectors are not as sensitive to data modulation energy if the data is at a higher frequency. Frequency translation moves the data energy away from the center frequency of the video carrier, and the higher-frequency data energy tends to be cancelled more by the Nyquist Complement Filter (“NCF”) 120 that follows the mixer 116 and by the Nyquist filter in the television receiver. That is, the roll-off resulting from the combination of the two filters severely attenuates signals far from the video carrier.

The NCF 120 counteracts the effects of the Nyquist filter in the television receiver. As described in U.S. Ser. No. 09/062,225 and PCT/US99/08513, which are incorporated herein by this reference, the NCF 120 may account for a single TV receiver's Nyquist filter, for a statistical combination of the Nyquist filters in different models of TV receivers, or for signals produced by emulation of such devices. The NCF also receives the CMC signals, described below. The NCF may be combined with a VSB filter.

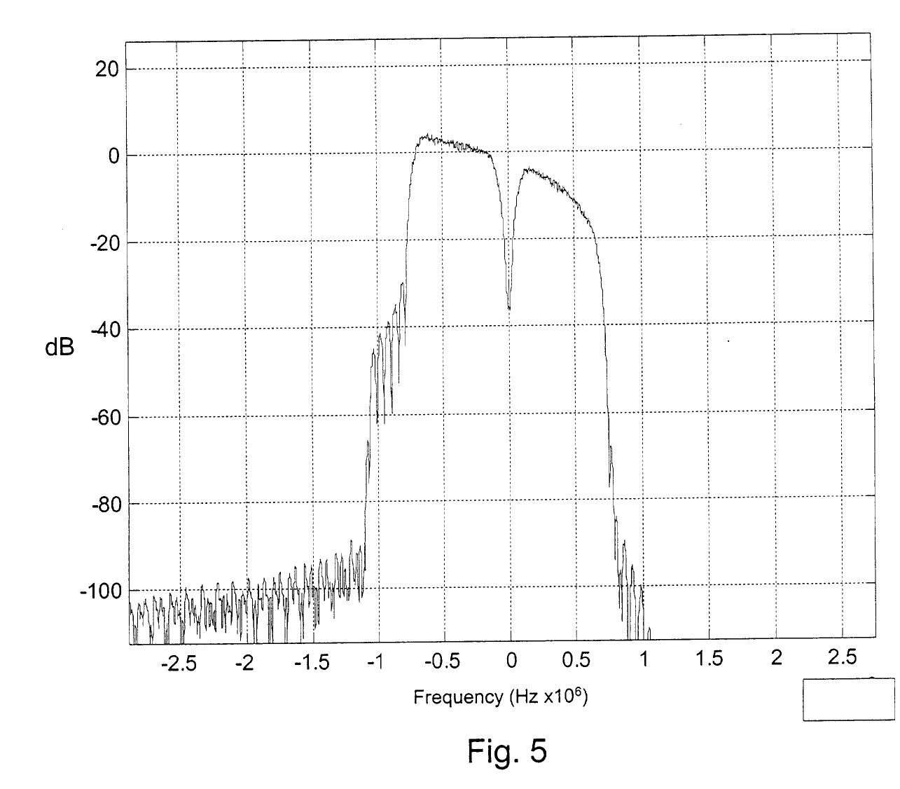

FIG. 5 is a data signal frequency plot which illustrates QAM data after passing through the NCF and VSB filter 120. The result is a complex wave shape with most of the data energy lying along the real axis. Prior to the 400 KHz subcarrier modulation, the signal is at complex baseband relative to the subcarrier frequency. By mixing with the subcarrier and taking the real part, the signal is in a signal space where the baseband is related to the video carrier.

Referring again to FIG. 1, the output of the NCF 120 is interpolated by two in interpolator 122, so that the data signal matches the rate of the video that is being fed into the abatement process.

Abatement Generator

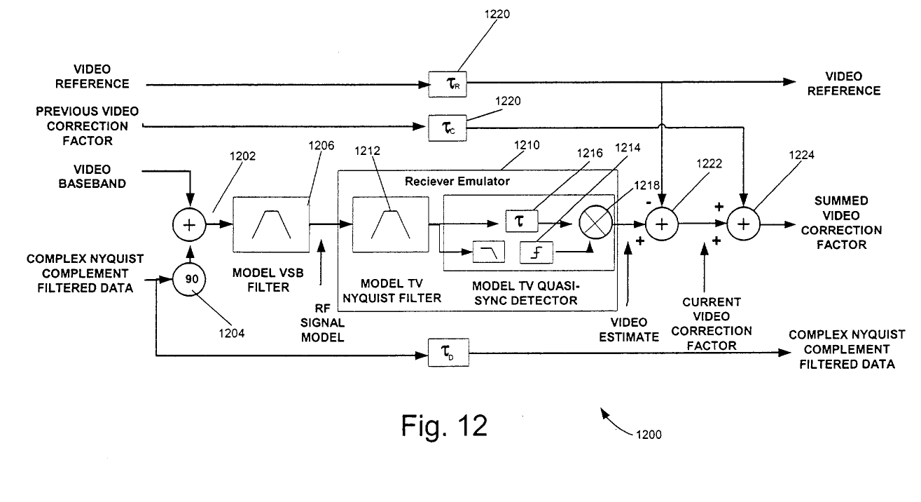

In the embodiment shown in FIG. 1, an abatement generator 124 receives a data signal, the output from the interpolator 122, and a video complex baseband signal, the output from the divide by 2 filter 102. The abatement generator 124 also receives channel metric control signals from a monitor receiver 160. From these inputs and functional elements described in connection with, among others, FIG. 12, the abatement generator outputs an abatement signal 125 and data signal 126. The abatement signal 125 is in-phase with the video signal and is used to correct, adjust, and/or modify the video signal at the point of the insertion, the coupler 142. The data signal 126 is a delayed version of the output from the interpolator 122.

Correction/Compensation Subsystem for Non-Linear Distortions

In a preferred embodiment, a correction/compensation subsystem 127 can be included in the transmitter encoder to correct and compensate for non-linear distortions. For example, as known in the art, non-linear distortions are introduced into the video signal as the signal passes through the power amplifier in the TV transmitter. The subsystem 127 receives, among other signals, channel metrics control signals from the monitor receiver 160 and outputs non-linear phase correction vector 128 and a non-linear amplitude correction factor 129.

Multipliers 121 and 123 are used to compensate the abatement signal 125 in amplitude and phase, respectively. Similarly, multipliers 131 and 133 are used to compensate the data signal 126 in amplitude and phase, respectively. A phase shifter 135 shifts in 90 degrees the data signal. A combiner 137 combines the phase and amplitude corrected abatement signal and the data signal that is shifted and compensated in phase and amplitude for non-linear distortions.

The simplest implementation of the correction/compensation subsystem 127 would be an embodiment where the amplitude and phase of the correction signal is a direct function of the instantaneous video voltage. The video voltage is appropriately scaled and offset, and used as the independent variable into a computation process that results in the appropriate complex correction factor. This computation process can be implemented in many ways, such as a simple linear or non-linear equation, a fixed lookup table, etc. More sophisticated implementations can include, for example, having the correction factor calculation process vary as a function of time, such as a using a different calculation during the vertical and horizontal sync intervals than during the active video interval. In alternative embodiments, the input to the calculation can have a value that is related to the past history of the video. An example of this is to use a filtered version of the video to drive the compensation calculations. A very desirable embodiment is to combine the concepts just discussed in a system that computes the correction factor based on the past and present values of video, using computation means that either vary discreetly (time multiplexed) or continuously (linearly combined) as a function of the video sync interval.

Data Signal Path: D/A Conversion and Transmission

A modulator, element 130 in FIG. 1, such as, for example, an Analog Devices AD9857 direct digital synthesis (“DDS”) modulator, includes an interpolator 132 which interpolates the output of the combiner 137 by 8. Mixer 134 then mixes the interpolated signal with a reference signal, which is, for example, at 45 MHz, from a reference oscillator, 136, and generates an intermediate frequency (IF) signal. A digital-to-analog converter, 138, converts the IF signal to analog form. An up-converter, 140, translates the resulting IF data-carrying analog signal to a standard TV channel frequency, such as channel 2, 4, 5, and etc.

Video Signal Interception and Local Oscillator Synchronization

An analog television transmitter outputs TV programming in, for example, NTSC format. TV video signals from the exciter 103 of the TV transmitter system shown in FIG. 1 are output at standard TV channel frequencies, such as channels 2, 4, 5, and etc. An RF coupler 150 couples this signal to a down-converter 152.

The down-converter 152 translates the TV signal to a nominal IF, for example, 45 MHz. A reference oscillator 154, implemented, for example, using an AD9851 DDS, runs off the same clock as the oscillator 136 and generates a reference signal at IF, which is, for example, at 45 MHz. In this example, the TV transmitter outputs an NTSC signal, which has an IF of approximately 45 MHz.

A phase lock loop (PLL) 156 compares the reference signal to the down-converted TV signal. Based on the comparison, the PLL adjusts a local oscillator synthesizer 158 so that the down-converted TV signal has the same phase and frequency as the reference.

The up-converter 140 and the down-converter 152 comprise nearly identical components. As a result of the phase locking of the down-converted TV signal, the corresponding adjustment signal of the local oscillator synthesizer 158 can be used to adjust the up-converter 140 so that the in-phase component of RF output signal (discussed below) has the same frequency and phase as the TV RF channel signal, i.e., the two signals are coherent. By adjusting the relative phase of the local oscillator 158 and the reference oscillator 154, it is therefore possible to adjust the relative phase of the reference RF signal and the dNTSC reference signal.

Channel Metric Control (CMC) Signals

A coupler 142 injects the up-converted data signal onto the TV RF signal. The coupler 142 output is fed to the transmitter through a power amplifier 162, and preferably also provided to one or more monitor receivers 160 which can be implemented in hardware or software or a combination, at any desired point or location, in any desired number and type.

At the injection point, imperfections in the components within the dNTSC encoder, for example, the phase shifter 134, the PLL 156 and the up/down-converters 140 and 152, make it difficult to maintain the desired quadrature relationship of the RF data signal to the TV signal, preferably as sensed by television receivers in the geographical area receiving television programming carried by the TV RF signal. The monitor receiver 160 is used to provide channel metric feedback parameters to signal processing elements in the data transmission path in order to address these issues, among others.

Data Injection Level and Phase Channel Metrics

The information-carrying RF signal injected at the injection coupler 142 includes an abatement, correction, modification and/or modulating signal along the in-phase axis (“abatement signal”), as well as a data signal along the quadrature axis relative to the phase of the television transmitter's visual carrier. The abatement signal is added to the television video signal from the TV transmitter, whereas the data signal is added in quadrature to the television video signal. One of the primary metrics that the monitor receiver 160 measures is the injection phase of the data signal to help ensure that the injection phase is in quadrature to the television visual (video) carrier. By using the monitor receiver 160, the data transmission system of the present invention more perfectly approaches the objective of having the injection phase within one degree of quadrature to the visual carrier.

Data Equalization Channel Metrics

Another metric measured by the monitor receiver is equalization. Various elements of the transmission system, including the VSB filter, the power amplifier and power combiners after the injection point, and differences between components in the up-converter and the down-converter, distort the frequency response of the RF data signal. Ideally, the frequency response of the data should be flat across frequency and phase and be free of uneven group delay. These distortions will also interfere with the video at the TV receiver.

Accordingly, the monitor receiver 160 monitors the frequency response of the data signal to provide a channel metric to the combined NCF and VSB filter 120 to cause the filter to preequalize the data, thereby minimizing distortion at the user's TV receiver. For example, to set the combined NCF and VSB filter 120 for pre-equalization, an equalizer training sequence can be input at the data input of the data transmission system. The monitor receiver 160 compares the spectrum of the received data to the known spectrum of the equalizer training sequence to determine the distortion to the spectrum. The equalizer training sequence is also used in the data receiver of the present invention, as described below.

Abatement Equalization and Optimization Channel Metrics

Other parameters measured by the monitor receiver 160 relate to abatement, where abatement is a process to apply a correction, adjustment, and/or modification signal to the television transmitter's visual carrier to reduce visible effects of the dNTSC data subcarrier upon an ordinary television receiver. Based on these abatement metrics the monitor receiver 160 provides parameters to the abatement generator 124, so that it can correct for distortions caused by processing of the signal after the abatement generator. One of the abatement parameters is abatement equalization, which relates to the selection of the filters that model the TV receivers used by the viewers in order to generate the abatement correction signal. Another abatement parameter is abatement optimization, which measures how well the abatement signal is doing, for example, when a particular TV receiver model receives the standard television signal transmitted by the transmitter system of the present invention.

Synchronization Offset Channel Metrics

Another monitored parameter is synchronization offset of dNTSC data relative to the broadcast color subcarrier reference. In general, the monitor receiver 160 employs an adaptive algorithm, for example, least mean square (LMS) or recursive least square (RLS), to adjust signal processing elements of the data transmitter, so as to minimize the error between the metrics and a desired reference parameter for each metric. Because these metrics are not expected to change rapidly over time, the algorithm need not adjust the transmitter signal processing in real-time, but may do so periodically at a slower rate. For example, a typical television transmitter diplexer may have phase and amplitude distortion which changes slowly as a result of temperature or aging. The adaptive algorithm will not be required to maintain a high update rate to track and remove these distortions.

Insertion Phase and Amplitude Channel Metric Generators

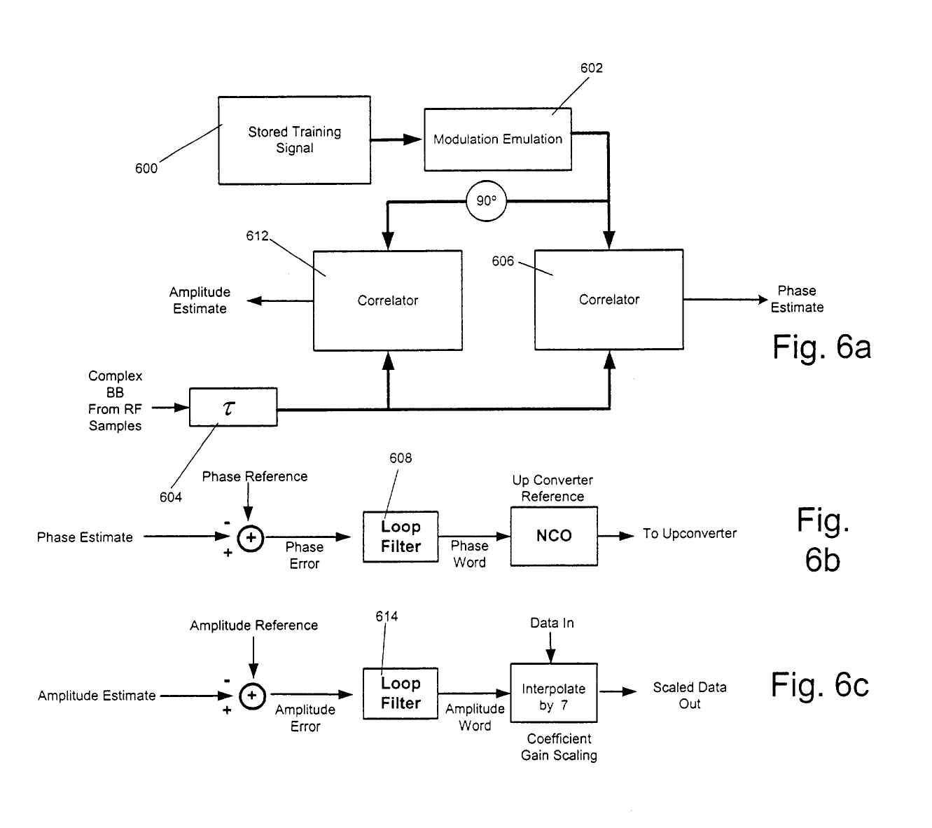

FIG. 6A illustrates a generator for injection phase and amplitude channel metric signals for use in the system of FIG. 1. A phase control generator 600 generates the same training sequence as the data transmitter. Such sequences can be drawn from a subset of a high order QAM constellation, for example a quadrature phase shift keying (QPSK) alphabet. A modulator or modulator emulator 602 modulates or emulates modulation of the training signal using the same signal processing as the transmitter up until the generation of the complex baseband signal after the complex 400 KHz subcarrier modulation. The resulting data signal is on the real axis.

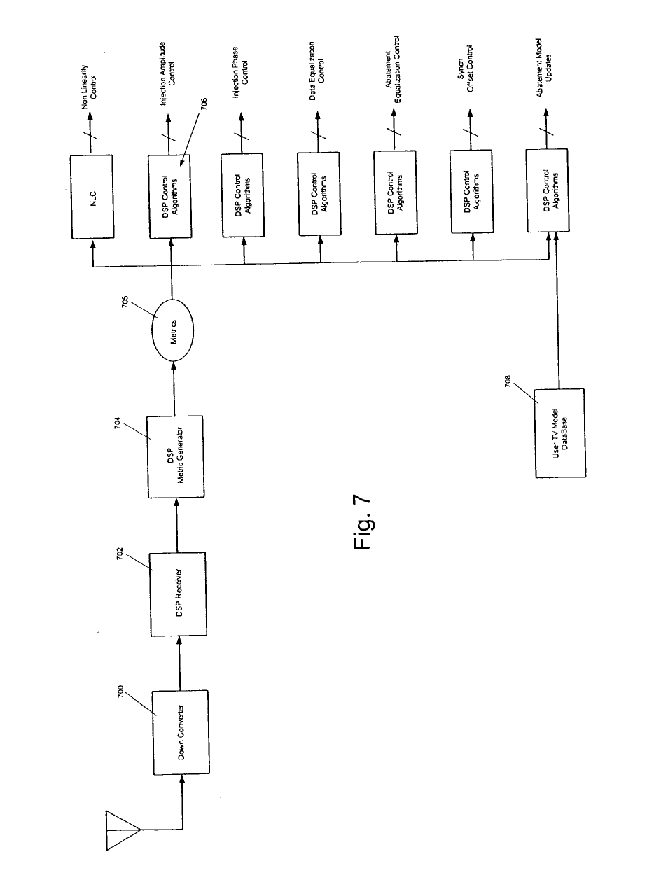

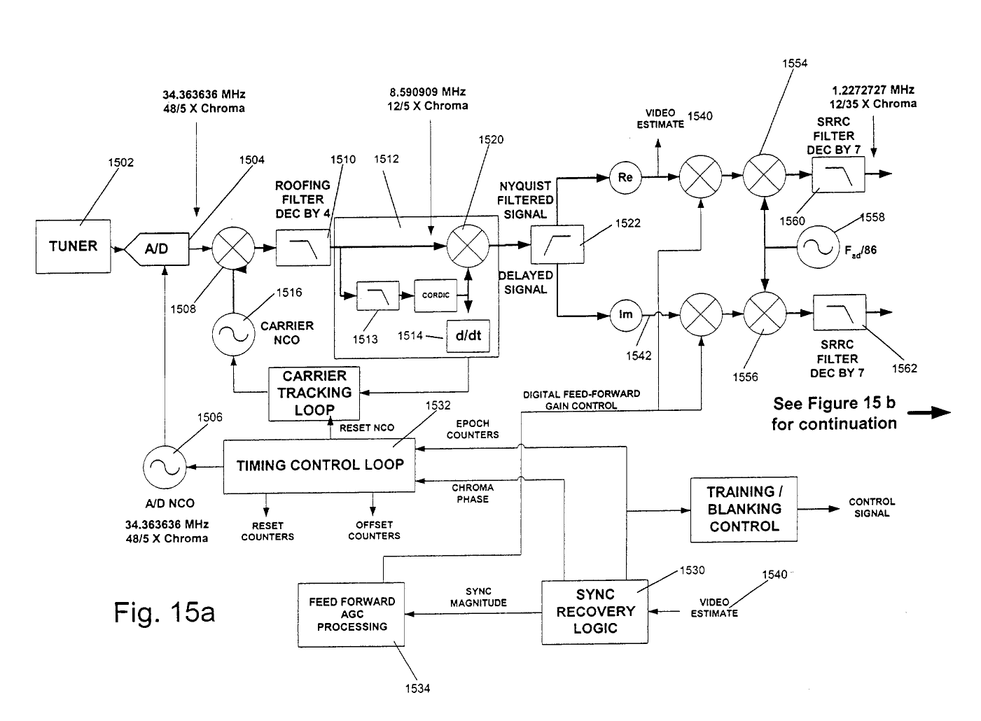

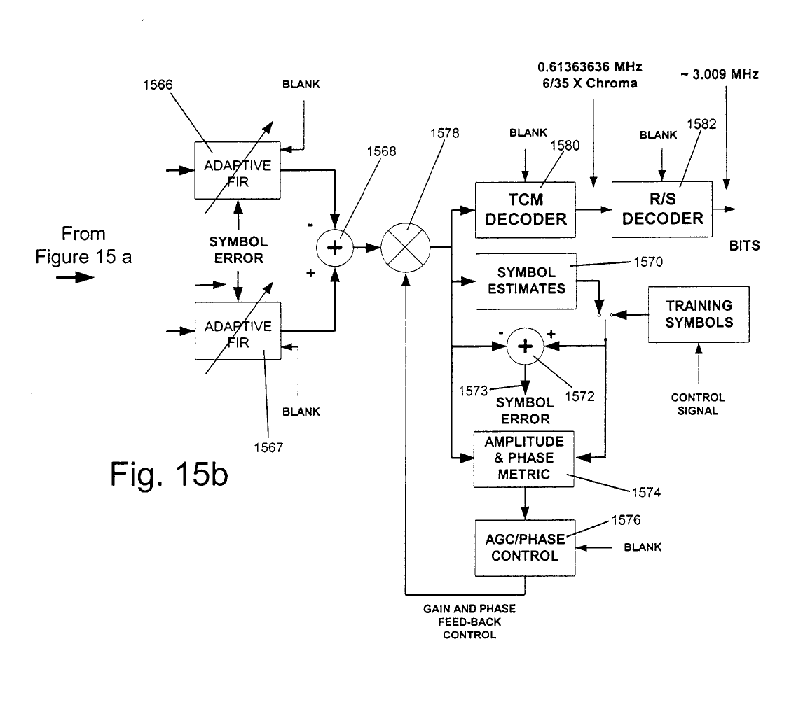

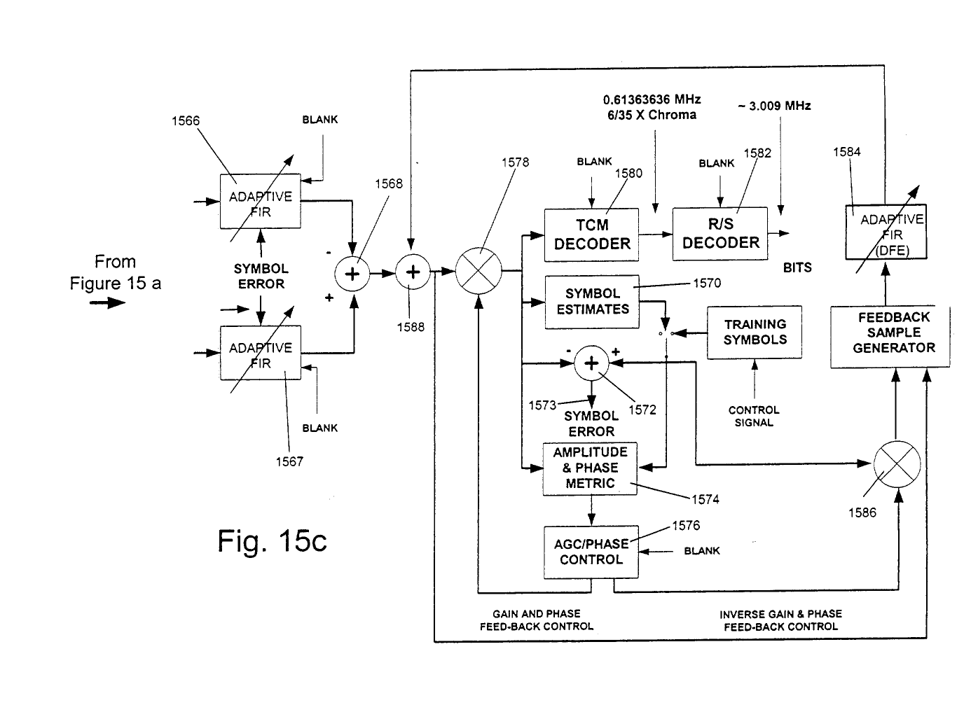

A delay element 604 is provided with a complex baseband signal received by the monitor receiver 160. That is, the monitor receiver 160 such as shown in FIG. 7 provides a received complex baseband signal from a stage of the DSP receiver corresponding to the output of the Quasi-Synchronous detector of the data receiver of FIG. 15 (before quadrature detection of the data) in response to a training sequence input. The delay element 604 delays the complex baseband signal to account for the delay of the training signal through the modulator 602.

A correlator 606 correlates the non-phase shifted modulated training signal 603 with the delayed complex baseband data according to: R_{xy}(τ)=∫x(t)y*(t−τ)dt where x is the modulated training signal, y is the complex baseband data and * is the complex conjugate.

The result is the phase error. The phase error should be zero if the received data is in quadrature to the real training signal data. A non-zero phase error represents a deviation of the received data from quadrature. One can also use a complex correlation algorithm that will provide a simultaneous estimate of both amplitude and phase. The correlator 606 can be modeled as a mixer followed by a low pass filter. As an alternative to using the training sequence, the actual data can be used if the monitor receiver has access to the signal data that is being transmitted. As shown in FIG. 6B, the phase error is passed through a filter 608 and applied to the reference oscillator in the encoder. This constitutes the closed loop control of the signal injection phase.

Referring again to FIG. 6A, note that a 90 degree phase shift, is applied to the modulated data signal to rotate it to the quadrature axis, so that it is in phase with the received data. Another correlator 612 correlates the phase-shifted data with the delayed complex baseband data signal to provide an amplitude estimate. As shown in FIG. 6C, the amplitude estimate is subtracted from an amplitude reference, which is derived from the video levels used in the calculation of the abatement signal. The difference (injection level error) is then filtered with a loop filter 614 using conventional techniques or as otherwise desired, such a filter could, for example be a second order loop filter with a closed loop response of

$$H ( s ) = \frac{K α}{{S}^{2} + α S + K α}$$

in continuous time form to create an amplitude word (injection level control signal). The parameters K and α are used to set the DC gain and pole locations of this filter. This control signal can be used to scale the coefficients of the interpolate-by-7 filter 114 of the transmitter encoder 100, thereby adjusting the gain and minimizing the injection level error.

Monitor receiver

The monitor receiver 160 can be coupled directly to the injection point through a directional coupler or it could include an antenna receiving the RF signal from the data transmitter. It may also be implemented in software or as otherwise desired. FIG. 7 illustrates a block diagram of an embodiment of the monitor receiver 160 used in connection with the embodiment of the transmitter side circuitry shown in FIG. 1. As in the data receiver 1500 shown in FIG. 15, the RF signal is down-converted to an intermediate frequency (IF) by a down-converter 700. A DSP receiver 702 then processes the IF signal in a manner which may be similar to the data receiver 1500 to recover the data. A DSP metric generator 704 generates metrics 705, which are related to the injection level, injection phase, data channel equalization, abatement equalization, abatement optimization and synchronization offset signals, for example. The metrics 705 are input to corresponding DSP control algorithms, collectively designated as 706, which produce the “channel metric” control signals to the NCF and other elements of the system of FIG. 1.

The monitor receiver 160 can emulate any number of same type or different type communication receivers operating under many conditions. For instance, several brand name television receivers could be emulated either in software or hardware, or a combination thereof, and their results weighted, to provide channel metrics that provide best operation of the system of FIG. 1 in a particular geographic area or market. In FIG. 7, a user's television model database 708 is used to generate the abatement model update control signal.

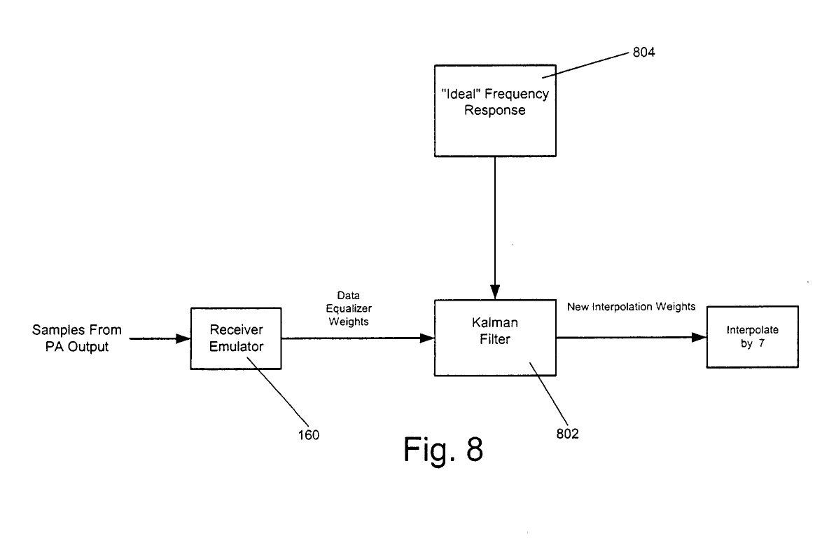

Data Channel Equalization Channel Metric Generator Referring to FIG. 8, an adaptive filter 802 (e.g. a Kalman filter such as described by Catlin, Donald in “Estimation, Control, and the Discrete Kalman Filter” Springer-Verlag, New York, N.Y., 1989) receives the weights of the data adaptive filter in the monitor receiver 160 after training and while the data receiver is in normal operation. The weights indicate the frequency response of the data filter. The adaptive filter 802 receives these weights and an ideal frequency response 804, e.g., a flat response. The adaptive filter 802 outputs new interpolation weights for the interpolate by 7 filter 114 to drive the error difference between the data filter and ideal weights to zero.

Synchronization Offset channel Metric Generator

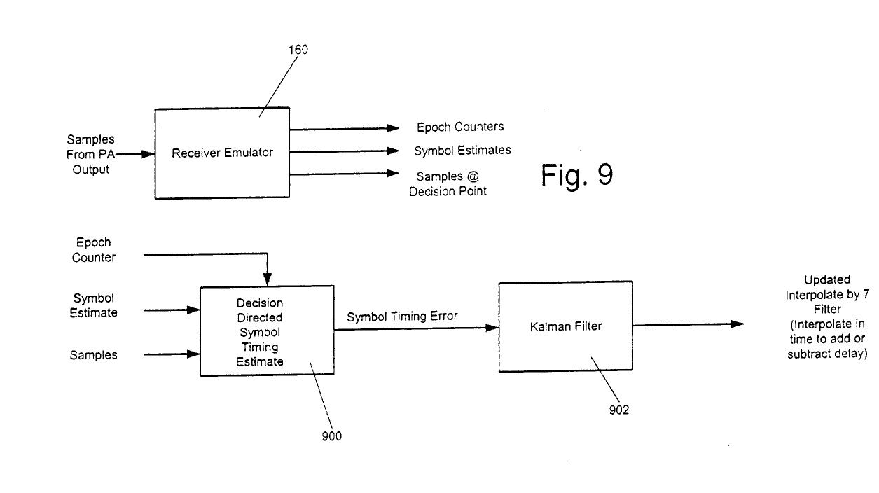

FIG. 9 illustrates synchronization offset control performed by the monitor receiver 160. A decision-directed symbol timing estimator 900 receives from the monitor receiver 160 during normal operation the epoch counters, the symbol estimates and received data samples at the decision points of the symbol estimator 900. Based on differences between the symbol estimates and the corresponding data samples, the Decision Directed (DD) symbol timing estimator outputs a timing error. For a discussion of Decision Directed timing recovery see: K. H. Mueller and M. S. Muller, “Timing Recovery in Digital Synchronous Data Receivers,” IEEE Transactions on Communications, vol. COM-24, pp. 516-531, May 1976.

Based on the timing error, an adaptive filter (such as the above-referenced Kalman filter) 902 provides updates to the interpolate-by-7 filter 114 to add or subtract enough delay to bring the timing error to zero. This delay is implemented by forming a new set of filter coefficients that shifts the impulse response by the appropriate amount of time.

Abatement Equalization Channel Metric Generator

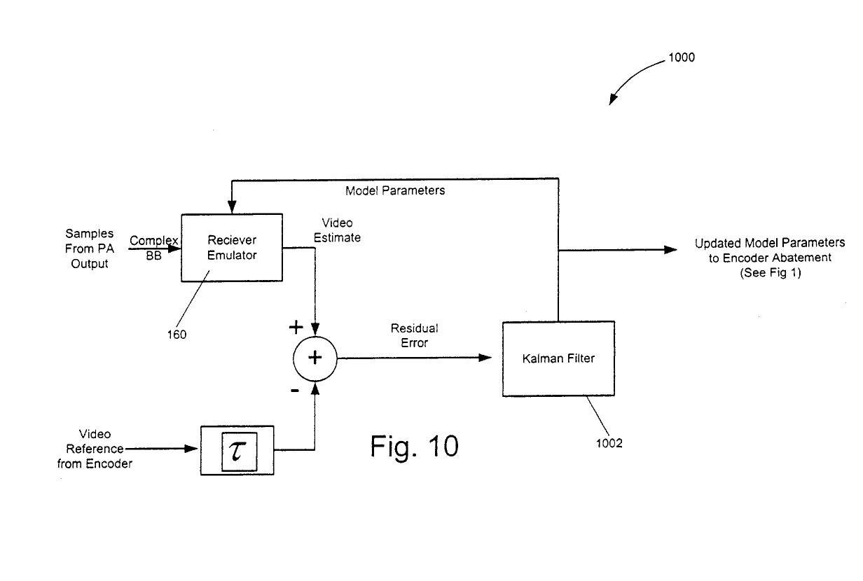

FIG. 10 illustrates the abatement equalization channel metric signal generator, 1000. The monitor receiver 160 takes the complex baseband signal at the output of the power amplifier 162 and outputs a video estimate, which is compared to the video reference from a video reference generator. The result is a residual error signal. An adaptive filter 1002 is used to provide model parameters to adjust a Nyquist filter in the monitor receiver 160 in order to minimize the residual error, i.e., make the complex baseband estimated video signal as close as possible to the video reference. These same parameters are output to adjust a Nyquist filter in the abatement generator 124.

Abatement Optimization Channel Metric Generator

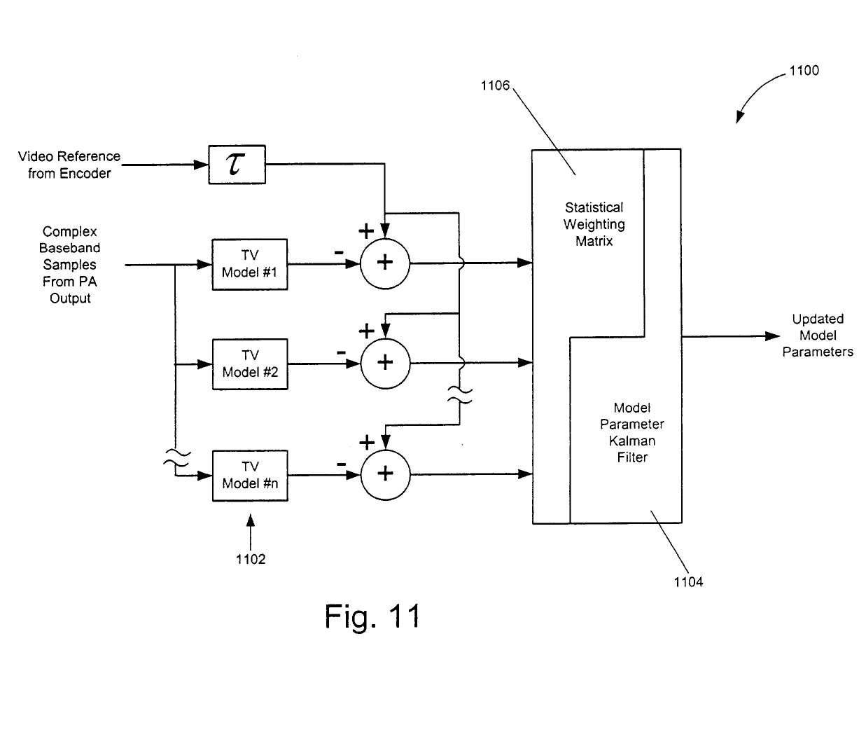

FIG. 11 illustrates the abatement optimization channel metric signal generator, 1100. Unlike abatement equalization, statistical abatement optimization can statistically account for not just one TV type, but different models of TV receivers, collectively designated as 1102, within a broadcast region. Optimization need not be a real-time process, but may be done periodically, for example, over days to weeks. Like abatement equalization, abatement optimization can compare the video estimate from each model TV receiver with the video reference to generate residual error signals. The abatement optimizer 1106 can statistically weight the residual error signals according to the statistical prevalence of the receiver model, for example, the popularity of particular TV sets within the region of broadcast. A Kalman or other adaptive filter 1104 then adjusts the model parameters to minimize the weighted residual errors. The resulting parameters are used to adjust the Nyquist filter in the model TV of the abatement generator 124.

Abatement Generators

FIG. 12 illustrates one stage 1200 of an embodiment of an abatement generator 124 shown in FIG. 1. In general, the abatement generator 124 models one or more TV receiver's processing of a television video signal that has had data imposed upon it by the data transmitter of the present invention. The abatement generator subtracts a television video reference signal from the emulated video that results from the model receiver's processing. The difference is a video correction factor that, preferably after an iterative process, is added in-phase to the television video signal.

An adder 1202 in the abatement generator receives the video complex baseband signal. A phase shifter 1204 shifts by 90 degrees the phase of the data after the combined NCF and VSB filter 120 and the interpolator 122 in FIG. 1. The adder 1202 combines this phase-shifted data with the video baseband signal. This addition mimics the addition of the data signal to the video signal at the injection point of the data transmitter, e.g., the coupler 142 in FIG. 1. A model VSB filter 1206 that emulates the VSB filter in one or more typical customer television sets and filters the sum signal output of the adder 1202.

The model VSB filter 1206 may emulate the VSB filter of a popular TV model within the region of a TV broadcast station, or, alternatively, represent a statistically weighted sum of the VSB filter coefficients for a number of TV models within the region. The weighting depends on the relative popularity of the corresponding television sets within the region. The filter output is designated as an RF signal model of the video signal representing one or more typical TV receivers. Note that this signal model is not actually an RF signal, but a complex baseband signal modeling the combined video and data signal.

For each television set represented in the system of FIG. 1, as a basis for abatement, consider that this model video signal is input to a model TV receiver 1210, which includes a model TV Nyquist filter 1212 and a model TV quasi-synchronous (QS) detector 1214. Like the model VSB filter 1206, these elements may represent the Nyquist filter and QS detector of one typical receiver or the weighted combination of corresponding elements of multiple receivers. Alternatively, a weighted sum of the video correction factors from multiple abatement generators, each designed to correct for a particular real-world TV receiver, may be used. The QS detector 1214 comprises a low pass filter and a limiter to generate a carrier estimate signal, as would be recognized by one skilled in the art. One can also use a very narrow synchronous detector or a very broad envelope detector. If the signal were shifted to IF, the low pass filter would represent a bandpass filter. The delay element 1216 accounts for the delay of the low pass filter and the limiter to time-align the signals in both paths of the QS detector when they are mixed in a mixer 1218. The mixing of the complex carrier estimate with the complex delayed output of the model Nyquist filter 1212 shifts the latter to baseband, thereby resulting in an estimate of the video signal at a model receiver by extracting the real part of the product. In other embodiments, simpler circuits can be used for abatement including single stage linear systems which for instance use no video component.

A video reference signal is delayed by a reference delay 1220 to account for the processing delay of the model VSB filter 1206 and the model TV receiver 1210. A combiner 1222 subtracts the delayed video reference from the video estimate to generate a video correction factor. In other words, the sum of the video correction factor and the video estimate would ideally result in the known video reference signal. Another combiner 1224 adds the video correction factor to the similarly-delayed video correction factor from a previous stage, if any.

Iterated Abatement Generators

The distortions that the data introduces to the television receiver detected video are the result of the non-linear processes described above. Because of this non-linear relationship, a single loop cannot completely remove the impairment caused by the presence of the dNTSC data. A theoretical solution would be the solution of a set of simultaneous non-linear equations. Such sets of equations result in a closed form solution that can be solved using an infinite series or an iterative approach. For example, the solution of RF non-linear device behavior is often handled using an iterative technique known as harmonic balance. This invention can handle it either way, among others, but the system of FIG. 1 embodies a solution to this particular non-linear system using a series approximation approach.

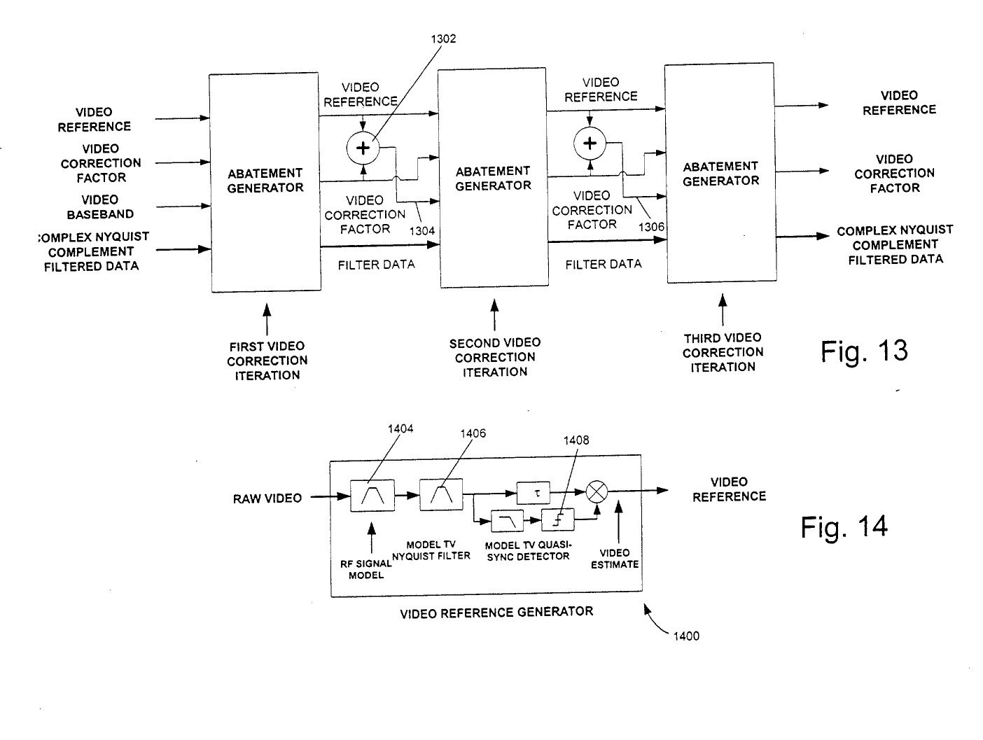

As shown in FIG. 13, the abatement stages of FIG. 12 are cascaded with the output of one stage contributing to the input of the next stage. Here, three stages are shown. After the first stage, an adder 1302 adds the video reference from the previous stage with the first-stage video correction factor to generate a first-order corrected video signal 1304, which substitutes as the input for the video baseband signal that was used in the first stage. At the output of the second stage, the corresponding sum would be a second-order corrected video signal, 1306. After each stage, the video correction factor better corrects the video. The final correction factor will likely not be perfect, however, because the video correction factor is only being added in-phase to the video as the abatement factor output of the abatement generator. Regardless, experiments show that three iterations obtain satisfactory results. Any number can be used or simulated.

FIG. 14 illustrates a video reference generator 1400 that provides the video reference for the abatement generator 124 in FIG. 1. As an alternative, the video reference can be the baseband video without any data that is input to the TV transmitter. The video reference generator includes a model VSB filter 1404 followed by a model TV Nyquist filter 1406 and a model QS detector 1408 as in the abatement generator stage 1200 illustrated in FIG. 12. However, the input to the video reference generator is the raw baseband video feed that is input to the standard TV transmitter without the data.

Receivers

FIG. 15 illustrates a preferred embodiment of a data receiver in accordance with aspects of the present invention. A television tuner circuit such as a conventional TV tuner circuit 1502 down converts the RF TV channel signal (e.g., at the frequency of channel 2, 4, etc.) to an IF (e.g., 45 MHz). Of course, in all embodiments of this application that refer to an RF signal, the signal can be a signal transmitted over a cable TV system, satellite, or otherwise. An A/D converter 1504 converts the analog IF signal to a digital TV signal. An A/D numerically controlled oscillator (NCO), or direct digital synthesizer (DDS) 1506 controls the A/D sampling rate to be approximately 34.3636 MHz, which has been chosen as 48/5×the chroma subcarrier frequency of the video. The choice of a system sampling frequency that has a rational relationship to the chroma sub-carrier frequency allows significant simplification of the receiver architecture.

A mixer 1508 down shifts the video intermediate frequency to zero hertz. The resulting zero frequency IF is represented with complex numbers and is commonly referred to as complex baseband. A complex roofing (low-pass) filter 1510 with an approximately four megahertz bandwidth is used to reduce the information bandwidth of the IF signal subsequent to sample rate reduction by four. The filter assures that the sample rate reduction process will not result in distortion of the IF signal through non-linear aliasing effects.

After the roofing filter 1510, a receiver QS detector 1512 is used for carrier recovery. The QS detector 1512 includes a bandpass filter and a limiter. The recovered carrier in the quasisynchronous detector can be passed through a frequency discriminator 1514 to form an estimate of the frequency offset relative to zero hertz. This estimate can be used as an input to a control loop which will adjust the frequency of the Carrier Numerically Controlled Oscillator (NCO) 1516 in order to reduce the frequency offset to zero. Recall that the data waveform has a notch around the video carrier. Accordingly, the passband of the filter 1513 is chosen so that it passes the video but not the data. Instead of a QS, a block phase estimator or a PLL may be used.

A mixer 1520 mixes the recovered carrier with the processed received signal to bring the received signal carrier down to DC, so that the video component is on the real axis. After the mixer, the signal is passed through a Nyquist filter 1522. The real part of the result is then taken. This provides a video estimate 1540, which is at baseband and is being sampled at 12/5×the chroma rate.

Using the video estimate 1540, a video processor 1530 (Sync Recovery Logic) recovers the amplitude of the sync pulses (sync magnitude) and the location of the television video signal with respect to the timing epoch and the chroma subcarrier phase. In an NTSC embodiment, an epoch is 525 lines or one frame of video. The video processor 1530 synchronizes epoch counters to be synchronous with the video frame.

Using the outputs from the video processor 1530, a timing control loop 1532 adjusts the A/D NCO 1506 to phase lock the receiver A/D sampling rate to the chroma subcarrier. In this manner, the A/D samples are referenced to the chroma subcarrier. However, the system must also identify which cycle it is currently processing. In NTSC, there are 227 ½ cycles/line. The timing control loop 1532 uses the epoch counter information to identify the cycle relative to the horizontal and vertical sync pulses. Therefore, the system has recovered the time reference of the TV signal, including adjustment of the A/D NCO receiver clock to match the clock of the transmitter system of FIG. 1. Once it is determined and controlled that the local time is synchronous with the video chroma sub-carrier and aligned with the video framing, the local data processing clocks are reset to ensure that the recovered data is sampled at the proper instance.

The sync magnitude output of the video processor 1530 represents the amplitude of the NTSC signal sync tips. A front end amplitude gain control (AGC) processor 1534 provides a gain control signal to a loop filter and scales the signal before the sub carrier mix. In other embodiments, this AGC control signal may be applied to the tuner 1502 to maintain the amplitude of the IF signal within the limits of the A/D. In the lower signal processing arm after the mixer 1520, a delay delays the signal the same amount as the Nyquist filter in the upper arm. The imaginary part of the delayed signal is then taken. This ideally results in a real QAM data signal in the form of a double-sided Nyquist-compensated waveform. The two signal processing arms together comprises a synchronous detector.

At this point, the system now has the video estimate 1540 and a data estimate 1542. The front end AGC 1534 provides a digital feed forward gain control signal to a first, video multiplier 1550 and a second, data multiplier 1552 to maintain a constant gain of the video and data signals with respect to the sync tip magnitude after detection of the video and data signals. This arrangement constitutes a dual detector path providing the advantages discussed below.

After the feed forward gain adjustment of the signals, a video down converter mixer 1554 and a data down converter mixer 1556 (together, “receiver down-converters”) mix the video and data estimates, respectively, with a signal having a frequency of Fad/86, where Fad is the sampling frequency of the A/D. This signal is produced by a local oscillator 1558. This results in a 400 KHz shift of the QAM signal of FIG. 2 to DC (complex baseband). The local oscillator frequency of Fad/86 was chosen so that the QAM signal of FIG. 2 could be shifted down to complex baseband using a simple numeric oscillator based on a lookup table. The video is similarly down converted to baseband.

A video square root raised cosine filter (SRRC) 1560 and a data SRRC 1562 are applied to the down converted video and data signals, respectively. These filters are matched to the transmit filters and will result in minimum inter-symbol interference in the absence of channel distortion. Because the signals are over sampled at this point, the filters also decimate the signals by seven, which brings the rate to two samples per symbol, which is the same frequency used at an early stage of the transmitter.

The receiver uses adaptive filtering to correct for channel distortions which could cause the video signal to interfere with the data on the quadrature axis. Other distortions to the data include effects such as multipath. The adaptive filters 1566 and 1567 perform both adaptive equalization and adaptive video cancellation using known techniques such as the least mean square (LMS) algorithm. (See for example B. Widrow et al: “Stationary and non-stationary learning characteristics of the LMS adaptive filter” Proceedings of the IEEE, August 1976). Note that the effect of the video on the data is much stronger than the effect of the data on the video because of the relatively low level of the data with respect to the video. The video itself is an unwanted component with respect to the recovery of the data. Moreover, because the video passes through the same signal processing as the data, it is similarly affected by multipath and other undesired effects. Accordingly, the video estimate is highly correlated with the undesired components present in the data estimate, and can be used to adaptively eliminate the distortions to the data mentioned above.

FIG. 15c shows another embodiment of the present invention that is consistent with such an approach. The equalization circuitry comprises a decision feedback equalizer (DFE) 1584 in addition to the two transversal, forward filters. All three filters are adaptive. The output of the switch that provides symbol estimates or training symbols is multiplied by inverse values of gain and phase control signals provided by the AGC Control 1576. The multiplier output is used as input to the adaptive DFE filter 1584 The output of the DFE is added 1588 to the output of the summer that combines the forward filter outputs. The DFE is itself an FIR filter that is embedded in a feedback loop, so its overall impulse response is of infinite duration.

Though the embodiments described above utilize an LMS approach to adaptive equalization, those skilled in the art will readily appreciate that numerous other approaches could be employed depending on the needs of any particular embodiment of the present invention. Examples could include Recursive Least-Squares (RLS) algorithms or other known methods for blind deconvolution such as stochastic gradient decent, Polyspectra or Bussgang approaches among others. Bussgang algorithms were first described by Julian J. Bussgang and David S. O. Middleton in “Optimum sequential detection of signals in noise” IEEE Transactions on Information Theory V.1 No 3; December 1955. Such Bussgang deconvolution techniques for blind equalization are implicit higher order statistics based algorithms.

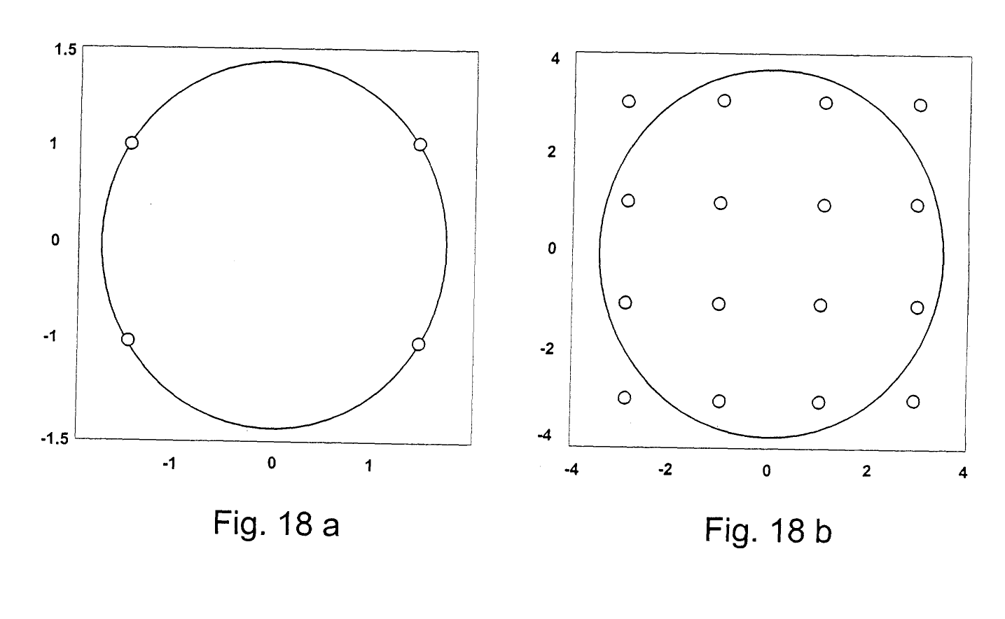

The Constant Modulus Algorithm (CMA) is a popular blind equalization algorithm that is robust in realistic signaling environments. Instead of relying on a reference or training sequence that occupies valuable bandwidth, CMA derives a reference from the received signal itself by penalizing dispersion of the magnitude squared equalizer output from a known constant that depends on the modulation type. For example, the FIG. 18A shows a 4-QAM constellation. Observe that the four alphabet members lie on a circle. CMA effectively penalizes dispersion from this circle. For multi-modulus source alphabets, like the 16-QAM constellation in FIG. 18B, a circle of best fit is determined, and CMA penalizes dispersion from this circle. As the density of the source constellation is increased, algorithm convergence and maladjustment (stochastic jitter) increase, though remarkably, CMA still adjusts the equalizer coefficients to the correct, desired setting. Hence, CMA is the blind equalization algorithm that is most frequently encountered in the current art. Other options include explicit higher order statistics algorithms or their discrete Fourier transforms known as Polyspectra. While still other approaches could include Cyclostationary statistic based algorithms and others.

The video adaptive FIR filter 1566 is used to predict the undesired components in the data estimate 1542. The data adaptive FIR filter 1567 predicts the data. The predicted undesired component is subtracted from the predicted data in a combiner 1568.

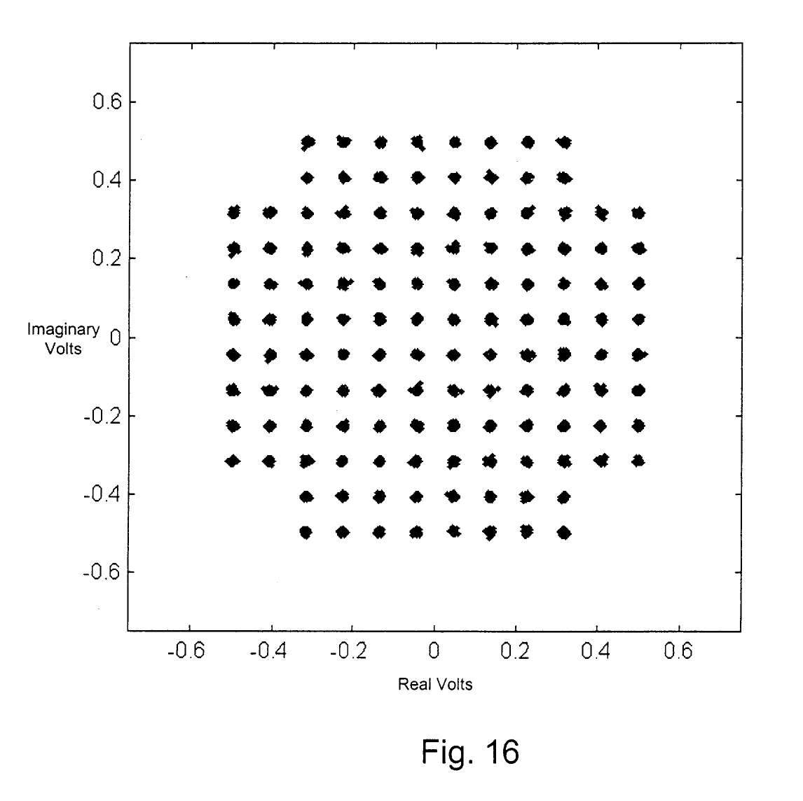

FIG. 16 illustrates the QAM data constellation after video cancellation and equalization by the adaptive filters. A symbol estimator 1570 makes a hard decision as to which symbol is being transmitted based on a comparison of the filtered data with appropriate thresholds. A subtractor 1572 subtracts the filtered data from the symbol estimate to derive a symbol error vector, 1573. The symbol error 1573 is fed back to the video and data adaptive filters 1566 and 1567, thereby providing “decision directed adaption”. The data adaptive filter 1567 shapes the data waveform to minimize the symbol error, and the video adaptive filter 1566 uses the symbol error to better predict the undesired components on the data. Based on the filtered data and the symbol estimate, a gain or a gain/phase error detector 1574 determines the gain and phase error of the filtered data. These errors are fed to an AGC/PLL 1576, which provides a gain/phase vector control signal to a multiplier 1578 after the combiner 1568 in order to correct for the gain or the gain and phase errors. Certain embodiments of the present invention use a feedback AGC as described in Provisional patent application No. 60/341,931. Such a feedback equalizer architecture can use feedback samples comprised of weighted contributions of scaled soft and inversely-scaled hard decision samples, and adapts forward and feedback filters using weighted contributions of update error terms, such as Constant Modulus Algorithm (CMA) and Least Mean Squares (LMS) error terms.

Combining weights are selected on a symbol-by-symbol basis by a measure of current sample quality. Such an AGC also employs an automatic gain control circuit in which the gain is adjusted at every symbol instance by a stochastic gradient descent update rule to provide scaling factors for the hard and soft decisions, thus minimizing novel cost criteria.

The filtered data is also input to a trellis code modulator (TCM) decoder 1580, which is followed by a Reed Solomon decoder 1582 to recover the original data to be provided for output.

Correction/Compensation for Non-linear Distortion from Power Amplifiers

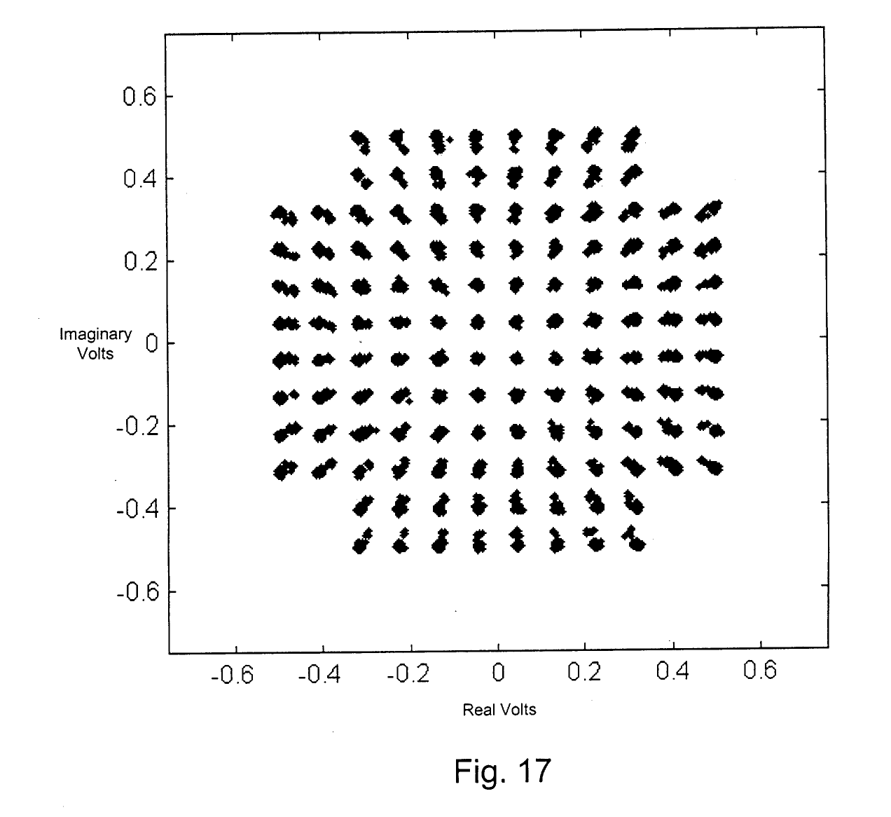

As is known in the art, the power amplifier in a TV transmitter has a non-linear gain response. In other words, at high powers the gain compresses, i.e., reduces. The power output of a TV transmitter is highest during transmission of the sync pulses. Experimental results show that this gain compression causes undesired effects on recovery of the data, as shown by the fuzziness of the data vectors in the QAM constellation of FIG. 17.

Another aspect of the invention may include compensation of transmitter non-linear amplitude and phase distortion in the dNTSC encoder. This compensation can consist of look up tables that generate gain and phase control words as a function of video amplitude. To avoid these effects, the transmitter of FIG. 1 does not transmit data when the sync pulses are at their maximum level. The data is arranged to be 39 symbols per TV scan line, with 4 symbols occurring during the horizontal sync pulse interval. Those 4 symbols do not carry information to be transmitted by the user. In addition, the transmitter does not transmit user information during the 9 lines of the vertical sync pulse interval, so 9×39=351 symbols of information are blanked out (not transmitted) per field during that time. The transmitter formats the data so that 188 bytes of data fit within each epoch. During the video blanked time, (e.g., the 9 vertically blanked lines) the transmitter outputs a training sequence. Such a sequences can be drawn from a subset of a high order QAM constellation, for example a quadrature phase shift keying (QPSK) alphabet. This training sequence remains the same each field, and is used to train the data equalizer in the receiver.

The receiver 1500 uses the training sequence in order to initialize the adaptive filter coefficients to start acquisition of the QAM data signal. Because the receiver 1500 has already recovered timing from the video, the receiver 1500 knows where to look in the video epoch for the training sequence. During the time of the training sequence, the output of the symbol estimator 1570 is not fed into the combiner 1572 or the gain/phase error detector 1574 as a reference signal. Instead, a switch switches in the training sequence as a reference into those elements. As a result, the combiner 1572 compares the filtered data to the training sequence, and the gain/phase error detector 1574 makes a similar comparison. Because the training sequence is a known desired signal (as opposed to only an estimate), the resulting outputs (symbol error, gain/phase feedback control) can be used to initialize the adaptive filter weights and the gain and phase of the filtered data. The use of training sequences for signal acquisition is known in the art (e.g., the acquisition of data for V.90 modems) and numerous approaches may be employed as an element of any particular embodiment of the present invention.

During the non-training sequence portion (i.e., other than the 9 vertically blanked lines of the video field) while the adaptive filters 1566 and 1567 are still in acquisition mode, the filter weights may be frozen (not change) or they may be adjusted with any one of a number of blind deconvolution algorithms. (See, for example, D. N. Godard, “Self-recovering equalization and carrier tracking in two dimensional data communication systems,” IEEE Transactions on Communications, vol. 28, no. 11, pp. 1867-1875, October 1980)

Acquisition mode continues for a number of fields (with the weights adjusting to each field's training sequence), and ends after the symbol error for the training sequence reaches a desired level, as is generally known in the art of data acquisition. When the symbol decision errors are reduced below a preset threshold then the acquisition is completed. After acquisition, the filters 1566 and 1567 adapt during both the non-training sequence portion and the training sequence portion of the video field. Alternatively, the filter weights can be calculated directly using the Wiener-Hopf direct solution if the computing power in the receiver is sufficient.

During the horizontal sync pulse interval, although four QAM symbols may encounter substantial interference, the system can alternatively transmit and receive a lower rate, lower complexity signal (e.g., QPSK) in a satisfactory manner. This allows the system to transmit approximately an additional 25-50 KB of data. These symbols can be used as a command channel to transmit instructions and status information to the receiver. To accommodate for this information, the receiver would include a parallel set of symbol estimator/error detector and AGC/PLL that is switched in during the horizontal sync pulse interval.

Having thus described a preferred embodiment of apparatus, systems and methods for adaptively expanding data capacity in transmission systems, it should be apparent to those skilled in the art that certain advantages have been achieved. It should also be appreciated that various modifications, adaptations, and alternative embodiments thereof, may be made within the scope and spirit of the present invention. The invention is further disclosed in terms of the following claims.

What is claimed is:

1. A method for simultaneously transmitting a data signal with a standard television signal, said method comprising:
generating an abatement signal;
producing a nonlinear amplitude correction signal to compensate for a non-linear distortion in a television transmitter system;
producing a nonlinear phase correction signal to compensate for a non-linear distortion in a television transmitter system;
adjusting the abatement signal based on the non-linear amplitude correction signal and the non-linear phase correction signal;
adjusting an internal data signal based on the non-linear amplitude correction signal and the non-linear phase correction signal;
generating a correction signal based on the adjusted abatement signal;
generating the data signal based on the adjusted internal data signal;
inserting the correction signal and the data signal to a television spectrum carrying the standard television signal.

2. The method of claim 1, wherein the abatement signal is generated using an iterative process, said iterative process comprising:
utilizing an output of a previous abatement stage as an input to a subsequent abatement stage.

3. The method of claim 1, wherein the non-linear amplitude correction signal and the non-linear phase correction signal are produced using a look-up table.

4. The method of claim 1, wherein the abatement signal is generated based on a feedback signal from a monitor receiver.

5. A method for simultaneously transmitting a data signal with a standard television signal, said method comprising:
generating an abatement signal based on at least one control signal from a monitor receiver;
combining a signal related to the abatement signal to an internal data signal; and
coupling a signal related to the combined signal to the television signal, thereby simultaneously transmitting the data signal with the standard television signal.

6. A method for controlling the phase of a data signal and a standard television signal, said data and television signals being transmitted simultaneously in a television spectrum, the method comprising:
producing a phase correction signal to compensate for distortion in a television transmitter system;
upward shifting the phase correction signal using a reference signal;
down converting the standard television signal to an intermediate frequency;
comparing the upward shifted phase correction signal with the down converted television signal;
adjusting a local oscillator used to down convert the standard television signal based on the comparison; and
using the local oscillator to up-convert an intermediate frequency signal to generate the data signal.

7. The method of claim 6, wherein the phase correction signal is adjusted with an insertion phase correction signal.

8. The method of claim 6, wherein the phase correction signal is produced based on at least one feedback control signal from a monitor receiver.

9. The method of claim 6, wherein the phase correction signal is produced using a lookup table.

10. The method of claim 6, wherein the phase correction signal is produced based an output from a television transmitter.

11. A method for transmitting a television spectrum comprising a standard television signal and a data signal, comprising:
receiving data;
passing a signal containing the data through a Nyquist complement filter means;
generating an abatement signal based on at least one channel metric from a monitor receiver means;
applying the abatement signal to the television to correct for effects of the data on the television signal;
applying the data signal to the television signal; and
simultaneously transmitting the data signal and the abated television signal, the data signal substantially in quadrature to the television signal as sensed at receivers for receiving the television signal.

12. The method of claim 11, wherein
the abatement signal is phase and amplitude adjusted before being used to generate a correction signal, said correction signal being in phase with the standard television signal; and
the output of the Nyquist complement filter is phase and amplitude adjusted and is shifted in quadrature before being used to generate the data signal.

13. The method of claim 11 further comprising:
producing an injection phase control signal in response to an injection phase of the data signal relative to the standard television signal; and
adjusting the phase of the abatement signal and the output of the Nyquist complement filter using the phase control signal.

14. The method of claim 11 further comprising:
monitoring the transmitted television spectrum;
producing an amplitude feedback control signal based on the monitored signal; and
adjusting the generation of the abatement signal using the amplitude feedback control signal.

15. The method of claim 11, comprising:
producing a frequency feedback control signal in response to a frequency response of the data signal; and
adjusting the generation of the abatement signal using the frequency feedback control signal.

16. The method of claim 11, comprising:
producing a synchronization feedback control signal by monitoring the transmitted television spectrum; and
adjusting the generation of the abatement signal using the synchronization feedback control signal.

17. The method of claim 11, comprising:
producing an abatement equalization signal based on the transmitted television spectrum; and
adjusting the generation of the abatement signal using the abatement equalization signal.

18. The method of claim 11, comprising:
producing an abatement optimization signal based on the transmitted television spectrum; and
adjusting the generation of the abatement signal using the abatement optimization signal.

19. A method for providing at least one feedback control signal in a transmitter system transmitting a spectrum comprising a standard television signal and a data signal, the method comprising:
receiving the television signal;
using a monitor receiver means, generating at least one feedback control signal to a transmitter system transmitting the television spectrum, generating an abatement signal based on the at least one feedback control signal to correct for effects of the data signal on the television signal; and
applying the abatement signal to the television signal.

20. The method of claim 19, wherein the at least one feedback control signal is used to adjust a Nyquist filter used to generate the abatement signal.

21. A method for transmitting a spectrum comprising a standard television signal and a data signal, the method comprising:
coupling a correction signal to the standard television signal;
generating at least one first feedback signal for adjusting an internal data signal related to the data signal and for adjusting an internal correction signal related to the correction signal;
adjusting the internal data signal based on the at least one feedback signal; and
adjusting the internal correction signal based on the at least one feedback, wherein the correction signal is substantially in phase with the standard television signal and the data signal is substantially in quadrature relative to the standard television signal.

22. A method for transmitting a television spectrum comprising standard television signal, a correction signal, and a data signal, the method comprising:
generating a phase control signal and an amplitude control signal based on the power level of the standard television signal;
generating an abatement signal;
adjusting the amplitude and phase of the abatement signal;
generating the correction signal based on the adjusted abatement signal;
adjusting the phase component of an internal data signal related to the data signal;
applying the correction signal and the data signal to the television signal, wherein the correction signal is substantially in phase with the standard television signal, and the data signal is substantially in quadrature relation with the standard television signal as sensed by receivers for receiving the television signal.

23. A method for simultaneously transmitting a standard television signal and a data signal within a television spectrum, comprising:
monitoring the amplitude of the standard television signal; and
causing a pause in the transmission of the data signal based on the amplitude of the standard television signal, wherein the pause enhances the quality of a reception of the standard television signal and the data signal.

24. The method of claim 23, wherein a sequence of training signals is transmitted during a vertical sync pulse interval of the standard television signal.

25. The method of claim 23, wherein the pause in the transmission of the data signal is caused when the sync pulses of the standard television signal are at their maximum level.

26. The method of claim 24, wherein command data is transmitted during a horizontal sync pulse interval.

27. A method for generating an insertion phase control signal used in a transmitter system for transmitting a standard television spectrum comprising a standard television signal and a data signal, the method comprising:
generating a sequence of information;
modulating the sequence of information through a first plurality of signal processing steps, said signal processing steps duplicating a second plurality of signal processing steps used to modulate a sequence of data used to generate the data signal;
providing a complex baseband signal recovered from the standard television spectrum;
correlating the modulated sequence of information with the complex baseband signal;
generating the insertion phase control signal based on the correlation; and
using the insertion phase control signal to control a phase relationship between the data signal and the standard television signal.

28. The method of claim 27, wherein the sequence of information comprises data signals.

29. The method of claim 27, wherein the sequence of information comprises training signals.

30. The method of claim 27, comprising:
shifting by 90 degrees the modulated sequence of information;
correlating the shifted sequence of information with the complex baseband signal and producing an amplitude correction signal; and
using the amplitude correction signal in at least one of the second plurality of processing steps.

31. The method of claim 30, wherein the second plurality of signal processing steps comprises interpolating a signal related to the sequence of data, and the amplitude correction signal is used to adjust the interpolation.

32. A method for generating an abatement equalization signal, comprising:
receiving a standard television spectrum comprising a standard television signal and a data signal;
recovering a video estimate from the standard television spectrum;
comparing the video estimate with a video reference signal and producing a residual error signal; and
utilizing an adaptive filter to minimize the residual error and obtain the abatement equalization signal.

33. The method claim 32, wherein the adaptive filter is a Kalman filter.

34. The method of claim 32, wherein a model TV receiver receives the standard television spectrum.

35. The method of claim 32, wherein the model TV receiver is a software emulator.

36. A method for generating an abatement optimization signal, comprising:
receiving a standard television spectrum comprising a standard television signal and data signal using a plurality of model TV receivers;
producing a plurality of model video estimates from the plurality of model TV receivers;
comparing each of the plurality of model video estimates with a video reference signal and generating a plurality of residual error signals;
producing a plurality of weighted residual error signals by statistically weighting each of the plurality of residual error signals according to a statistical prevalence of the corresponding model TV receiver within a broadcast region; and
utilizing an adaptive filter to minimize the plurality of weighted residual errors and generate the abatement optimization signal.

37. The method of claim 36, wherein the adaptive filter is a Kalman filter.

38. The method of claim 36, wherein at least one of the plurality of model TV receivers is an emulator of a standard television receiver.

39. The method of claim 36, wherein at least one of the model TV receiver is a software emulator of a standard television receiver.

40. An abatement generator comprising:
at least one emulator modeling a first standard television receiver, said emulator modeling a receipt of a standard television spectrum comprising a standard television signal and a data signal by the first standard television receiver and
a combiner for producing a difference between a video reference signal and an output of the emulator, said difference being used to control the phase relationship between the standard television signal and the data signal.

41. The abatement generator of claim 40, wherein the difference is input to another emulator modeling a second standard television receiver to produce an iterative difference, said iterative difference being used to control the phase relationship between the standard television signal and the data signal.

42. The abatement generator of claim 40, wherein the emulator comprises:
a model vestigial sideband (“VSB”) filter;
a model TV Nyquist filter; and
a model Quasi-synchronous (“QS”) detector.

43. The abatement generator of claim 42, wherein the VSB filter emulates a VSB filter of a typical TV receiver within a broadcast region.

44. The abatement generator of claim 42, wherein the VSB filter represents a statistically weighted sum of a plurality of VSB filter coefficients for a plurality of TV receivers within a broadcast region.

45. The abatement generator of claim 42, wherein the model Nyquist filter and the QS detector emulates a typical TV receiver within a broadcast region.

46. The abatement generator of claim 42, wherein the model Nyquist filter and the QS detector represents a weighted sum of a plurality of Nyquist filters and QS detectors present in a plurality of TV receivers within a broadcast region.

47. A method of receiving a standard television spectrum comprising a standard video signal and a data signal, comprising:
receiving the standard television spectrum;
recovering the carrier of the television spectrum;
producing a video signal estimate and a data signal estimate;
recovering a sync magnitude based on the video signal estimate;
amplitude adjusting the video and data signal estimates based on the recovered sync magnitude;
performing an adaptive equalization and a video cancellation; and
providing a processed data signal.

48. The method of claim 47 further comprising:
shifting the received standard television spectrum to an intermediate frequency (“IF”); and
converting the shifted spectrum a digitized television signal using an A/D converter; wherein the sampling frequency is related to the frequency of the chroma subcarrier of the standard television spectrum.

49. The method of claim 47 further comprising:
processing the down shifted and amplitude adjusted video signal estimate through a first square root raised cosine (“SRRC”) filter and a first decimator; and
processing the down-shifted and amplitude adjusted data signal estimate through a second SRRC and a second decimator.

50. The method of claim 47, wherein the adaptive equalization comprises;
producing a predicted data signal by adaptively filtering a modulated data signal obtained from the data signal estimate;
producing a predicted undesirable component in the predicted data signal based on the video signal estimate; and
subtracting the predicted undesirable component from the predicted data signal, wherein the result of the subtraction is used to produce the processed data signal.

51. The method of claim 47, wherein a symbol estimator provides a symbol error control signal which is used to perform the adaptive equalization and the video cancellation.

52. The method of claim 51, wherein the symbol estimator comprises:
a decision block for producing a symbol estimate signal, and a combiner for subtracting a signal related to the output of the adaptive equalization and the video cancellation (the “Internal Processed Data Signal”) from the symbol estimate signal to produce the symbol error control signal.

53. The method of claim 52, wherein a gain control signal is produced based on the symbol estimate signal and the Internal Processed Data Signal, and the gain control signal is used to produce a subsequent Internal Processed Data Signal.

54. The method of claim 47, wherein the Internal Processed Data Signal is further modulated using a trellis code modulation decoder and a Reed Solomon decoder to generate the processed data signal.

55. The method of claim 47, wherein a training sequence is used to initialize at least one adaptive filter used to perform the adaptive equalization and video cancellation.

56. The method of claim 49, wherein at least one weight used to control the at least one adaptive filter used to perform the adaptive equalization and video cancellation does not change during an acquisition mode.

57. The method of claim 49, wherein a Wiener-Hopf direct solution is used to adjust at least one adaptive filter used to perform the adaptive equalization and video cancellation.

58. A system for simultaneously transmitting a data signal with a standard television signal, said method comprising:
an abatement generator for generating an abatement signal;
a compensator for generating a correction signal to compensate for a non-linear distortion;
means for adjusting the abatement signal with the correction signal;
means for adjusting an internal data signal related to the data signal with the correction signal;
a combiner for combining the adjusted abatement signal and the adjusted internal data signal;
an up-converter for translating a signal related to the combined abatement signal and the internal signal to produce the data signal; and
a power amplifier for transmitting a composite television spectrum comprising the data signal and the standard television signal.

59. The system of claim 58, wherein the abatement generator comprises a plurality of abatement stages for producing the abatement signal using an iterative process.

60. The method of claim 58, wherein the compensator comprises a look-up table.

61. The method of claim 58, wherein the abatement generator receives at least one feedback signal from a monitor receiver.

62. A system for simultaneously transmitting a data signal with a standard television signal, said method comprising:
an abatement generator for generating an abatement signal based on at least one control signal from a monitor receiver;
a combiner for combining a signal related to the abatement signal and an internal data signal, said internal data signal being related to the data signal and being in substantial quadrature relationship to the signal related to the abatement signal;
a means for modulating and converting the combined signal to an analog signal;
an up-converter for producing the data signal from the output of the modulator; and
a coupler for inserting the data signal to a television spectrum carrying the standard television signal.

63. A system for controlling the phase of a data signal relative to a standard television signal, said data and television signals being transmitted simultaneously in a television spectrum, the system comprising:
a compensator for generating a nonlinear phase correction signal for a non-linear distortion in a television transmitter system;
means for modulating and shifting upward in frequency the non-linear phase correction signal using a reference signal;
a down converter for shifting down in frequency the standard television signal to an intermediate frequency using a local oscillator;
a comparator for comparing the upward shifted non-linear phase correction signal with the down converted television signal and providing a control signal to adjust the local oscillator; and
an up-converter for shifting upward in frequency an intermediate frequency signal related to the data signal, wherein the up-converter uses a reference signal from the local oscillator.

64. The method of claim 63, wherein the non-linear phase correction signal is adjusted with an insertion phase correction signal.

65. The method of claim 63, wherein the compensator receives at least one feedback control signal from a monitor receiver.

66. The method of claim 63, wherein the compensator comprises a lookup table.

67. The method of claim 63, wherein the compensator receives a feedback control signal which is generated based on a receipt of the television spectrum.

68. A system for transmitting a television spectrum comprising a standard television signal and a data signal comprising:
a receiver for receiving data information;
an interpolator for interpolating a signal corresponding to the received data information;
a mixer for frequency shifting the interpolated signal;
a Nyquist complement filter (“NCF”) and a vestigial sideband filter (VSBF”) for modulating the frequency shifted and interpolated signal;
an abatement generator for generating an abatement signal;
a combiner for combining a first signal related to the abatement signal and second signal related to the output of the NCF and VSBF;
an up-converter for frequency shifting the combined first and second signals,
a coupler for inserting the frequency shifted and combined first and second signals into the television spectrum carrying the standard television signal; wherein the first signal is substantially in phase with the standard television signal and the second signal is substantially in quadrature relationship with the standard television signal.

69. The system of claim 68, wherein
the abatement signal is adjusted in phase and amplitude to produce the first signal; and
the output of the NCF and VBSF is adjusted in phase and amplitude and shifted in quadrature to produce the second signal.

70. The system of claim 69 further comprising:
a compensator for producing a phase control signal in response to an injection phase of the data signal relative to the standard television signal; and
a local oscillator providing a reference signal to the up-converter, wherein the local oscillator is adjusted based on the phase control signal.

71. The system of claim 69 further comprising:
a television emulator for producing an amplitude feedback control signal, wherein the interpolator receives the amplitude feedback signal.

72. The system of claim 71 wherein the interpolator is an interpolator by 7.

73. The system of claim 69, comprising:
a television emulator for producing a frequency feedback control signal, wherein the interpolator receives the frequency feedback control signal.

74. The system of claim 69, comprising:
a television emulator for producing a synchronization feedback control signal, wherein the interpolator receives the synchronization feedback control signal.

75. The system of claim 69, comprising:
a television emulator for producing an abatement equalization signal, wherein the abatement generator receives the abatement equalization signal.

76. The system of claim 69, comprising:
a television emulator for producing an abatement optimization signal, wherein the abatement generator receives the abatement optimization signal.

77. A system for simultaneously transmitting a standard television signal and a data signal within a standard television spectrum, comprising:
a compensator for monitoring the amplitude of the standard television signal, wherein the transmission of the data signal is paused based on the amplitude of the standard television signal.

78. The system of claim 77, comprising a sequence generator for transmitting a sequence of training signals simultaneously with the standard television signal during a vertical sync pulse interval of the standard television signal.

79. The system of claim 77, wherein command data is transmitted during a horizontal sync pulse interval of the standard television signal.

80. A monitor receiver for generating an insertion phase control signal used in a transmitter system for transmitting a standard television spectrum comprising a standard television signal and a data signal, comprising:
a generator of a first sequence of data;
a modulator for modulating the sequence of data to duplicate a plurality of signal processing steps used to modulate a second sequence of data transmitted as the data signal;
a receiver for recovering a complex baseband signal from the standard television spectrum;
a correlator for correlating the modulated first sequence of data with the complex baseband signal;
a generator for generating the insertion phase control signal based on the output of the correlator; and
an output means for providing the insertion phase control signal to the transmitter system to control the phase relationship between the data signal and the standard television signal.

81. The monitor receiver of claim 80, wherein the first sequence of data comprises training signals.

82. The monitor receiver of claim 80, comprising:
a phase shifter for shifting by 90 degrees the modulated first sequence of data; and
another correlator for correlating the shifted sequence with the complex baseband signal to generate an amplitude correction signal; wherein the output means provides the amplitude correction signal to the transmitter system to control at least one of the plurality of processing steps.

83. The monitor receiver of claim 80, comprising:
a comparator for comparing a video estimate with a video reference signal and producing a residual error signal; and
an adaptive filter for minimizing the residual error signal and providing an abatement equalization signal.

84. The monitor receiver of claim 83, wherein the adaptive filter is a Kalman filter.

85. The monitor receiver of claim 80, wherein at least a part of the monitor receiver is implemented in software.

86. A monitor receiver for generating an abatement optimization signal used in a transmitter system for transmitting a standard television spectrum comprising a standard television signal and a data signal, the monitor receiver comprising:
a plurality of model TV receivers for receiving the standard television spectrum, each model TV receiver producing a model video estimate;
a comparator for comparing each model video estimate with a video reference signal and generating a corresponding residual error signal;
a statistically weighting component for weighting each of the plurality of residual error signals according to a statistical prevalence of the corresponding model TV receiver within a broadcast region; and
an adaptive filter for minimizing the plurality of weighted residual errors and obtaining the abatement optimization signal.

87. The monitor receiver of claim 86, wherein the adaptive filter is a Kalman filter.

88. The monitor receiver of claim 86, wherein at least one of the plurality of model TV receivers is an emulator of a standard television receiver.

89. The monitor receiver of claim 86, wherein at least one of the plurality of model TV receivers is a software emulator of a standard television receiver.

90. An abatement generator comprising:
at least one emulator modeling a first standard television receiver, said emulator receiving a signal modeling a standard television spectrum comprising a standard television signal and a data signal and producing a video estimate; and
a combiner for producing a difference between a video reference signal and the video estimate, wherein the difference is used to control the transmission of the standard television signal and the data signal.

91. The abatement generator of claim 90, wherein the difference is input to another emulator modeling a second standard television receiver to produce an iterative difference.

92. The abatement generator of claim 90, wherein the at least one emulator comprises:
a model vestigial sideband (“VSB”) filter;
a model TV Nyquist filter; and
a model Quasi-synchronous (“QS”) detector.

93. The abatement generator of claim 92, wherein the VSB filter emulates a VSB filter of a typical TV receiver within a broadcast region.

94. The abatement generator of claim 92, wherein the VSB filter represents a statistically weighted sum of a plurality of VSB filter coefficients for a plurality of TV receivers within a broadcast region.

95. A receiver for receiving a standard television spectrum comprising a standard television signal and a data signal comprising:
a tuner for receiving the standard television spectrum;
a mixer for recovering the carrier of the television spectrum;
a Nyquist filter producing a video estimate signal and a data estimate signal based on the recovered carrier and the received standard television spectrum;
a sync recovery processor for recovering a sync magnitude based on the video estimate signal;
a gain controller for adjusting the video and data estimate signals based on the recovered sync magnitude;
at least one adaptive filter for performing an adaptive equalization and video cancellation; and
an output means for providing a processed data signal based on the output of the at least one adaptive filter.

96. The receiver of claim 95 further comprising:
a down converter for shifting the received standard television spectrum to an intermediate frequency (“IF”); and
an A/D converter for converting the IF spectrum to a digital signal; wherein the sampling frequency of the A/D converter is related to the chroma subcarrier of the standard television signal.

97. The receiver of claim 95 further comprising:
at least one square root raised cosine (“SRRC”) filter; and
a decimator for modulating the video and data estimate signals.

98. The receiver of claim 95, comprising a first combiner for subtracting an undesirable component from a predicted data signal an internal processed data signal relating to the processed data signal, wherein
the at least one adaptive filter comprises a first and second adaptive filters, the first adaptive filter producing the predicted data signal by adaptively filtering a modulated data signal obtained from the data estimate signal; and the second adaptive filter producing the undesirable component in the predicted data signal by adaptively filtering a modulated video signal obtained from the video estimate signal.

99. The receiver of claim 98 further comprising a symbol estimator for providing a symbol error control signal to the first and second adaptive filters.

100. The receiver of claim 99, wherein the symbol estimator comprises:
a decision block for producing a symbol estimate signal; and
a second combiner for subtracting the internal processed data signal from the symbol estimate signal to produce the symbol error control signal.

101. The receiver of claim 100 comprising another gain controller for producing a gain control signal to the first combiner based on the symbol estimate signal.

102. The receiver of claim 95, further comprising a trellis code modulation decoder and a Reed Solomon decoder for modulating a signal related to the output of the at least one adaptive filter and producing the processed data signal.

103. The receiver of claim 95, wherein a sequence of training signals is used to initialize the at least one adaptive filter.

104. The receiver of claim 95, wherein at least one weight used to control the at least one adaptive filter does not change during an acquisition mode.

105. The receiver of claim 95, wherein a Wiener-Hopf direct solution is used to adjust the at least one adaptive filter.
